(19) United States
(12) Patent Application Publication
(10) Pub. No.: US 2024/0258567 A1
(43) Pub. Date: Aug. 1, 2024

(54) NON-AQUEOUS ELECTROLYTIC SOLUTION BATTERY

(71) Applicant: MURATA MANUFACTURING CO., LTD., Kyoto (JP)

(72) Inventors: Yurika UENO, Kyoto (JP); Kohei WATANABE, Tokyo (JP); Jun YAGISAWA, Tokyo (JP)

(21) Appl. No.: 18/436,508

(22) Filed: Feb. 8, 2024

(30) Foreign Application Priority Data
Jan. 31, 2023 (JP) 2023-186806
Feb. 16, 2023 (JP) 2023-024499

(51) Int. Cl. H01M 10/0567; H01M 4/02; H01M 4/50; H01M 4/62; H01M 4/76; H01M 10/0568; H01M 10/0569; H01M 50/193

(52) U.S. Cl. CPC H01M 10/0567; H01M 4/502; H01M 4/623; H01M 4/625; H01M 4/76; H01M 10/0568; H01M 10/0569; H01M 50/193; H01M 2004/021; H01M 2004/028; H01M 2300/0037

(57) ABSTRACT

A non-aqueous electrolytic solution battery is provided and including a positive electrode containing a positive electrode mixture containing manganese dioxide, a negative electrode containing a lithium element, and a non-aqueous electrolytic solution, in which in an X-ray photoelectron spectroscopy (XPS) spectrum of the positive electrode mixture, a peak intensity ratio I₂/I₁ of Mn2p_{3/2} satisfies a following formula (1)

$$0.3 ≦ \frac{{I}_{2}}{{I}_{1}} ≦ 0.55 \qquad ( 1 )$$

in the formula (1), I₁ represents a peak intensity at a binding energy of 642 eV, and I₂ represents a peak intensity at a binding energy of 640 eV.

### CROSS REFERENCE TO RELATED APPLICATIONS

The present application claims priority to Japanese patent application no. 2023-024499, filed on Feb. 16, 2023, and Japanese patent application no. 2023-186806, filed on Jan. 31, 2023, the entire contents of which are incorporated herein by reference.

### BACKGROUND

The present disclosure relates to a non-aqueous electrolytic solution battery.

In recent years, applications of primary batteries under high-temperature environments have been expanded, and for example, in-vehicle sensors (pressure sensors in tires) are used at about 100° C. In general, under a high-temperature environment, carbon dioxide is generated by oxidation of an organic solvent mainly in addition to volume expansion of the organic solvent contained in an electrolytic solution, which may cause a problem of deformation of a battery. With the expansion of the application, the primary battery is required to suppress the occurrence of such a defect (that is, excellent heat resistance is obtained).

For example, in a battery, a positive electrode surface is covered with an alkyl sulfonate ion R—SO₃⁻or a compound containing the ion to prevent contact of an electrolytic solution with the positive electrode, thereby suppressing decomposition of an organic solvent in the electrolytic solution. This indicates that battery swelling is suppressed to less than 0.10 mm after storage for 350 hours in an environment of 120° C.

In a battery, a positive electrode surface is coated with LiBF₄ contained as an additive in a non-aqueous electrolytic solution to prevent contact of the electrolytic solution with the positive electrode, thereby suppressing decomposition of an organic solvent in the electrolytic solution. This indicates that battery swelling is suppressed to less than 0.35 mm after storage for 240 hours in an environment of 125° C.

### SUMMARY

The present disclosure relates to a non-aqueous electrolytic solution battery.

The present disclosure, in an embodiment, relates to providing a non-aqueous electrolytic solution battery having excellent heat resistance.

In an embodiment, a flat-type non-aqueous electrolytic solution battery is provided having excellent heat resistance under a high temperature environment, for example, under a temperature environment of 150° C. or higher.

A flat-type non-aqueous electrolytic solution battery according to an embodiment of the present disclosure includes a positive electrode containing a positive electrode mixture containing manganese dioxide, a negative electrode containing a lithium element, and a non-aqueous electrolytic solution, in which in an X-ray photoelectron spectroscopy (XPS) spectrum of the positive electrode mixture, a peak intensity ratio I₂/I₁ of Mn2p_{3/2} satisfies the following formula (1):

$$\begin{matrix}[ Math . 1 ] & \\ 0.3 ≦ \frac{{I}_{2}}{{I}_{1}} ≦ 0.55 & ( 1 )\end{matrix}$$

[in the formula (1), I₁ represents a peak intensity at a binding energy of 642 eV, and I₂ represents a peak intensity at a binding energy of 640 eV].

The present disclosure can provide a flat-type non-aqueous electrolytic solution battery having excellent heat resistance under a high-temperature environment according to an embodiment.

### BRIEF DESCRIPTION OF THE FIGURES

FIG. 1 is a sectional view showing a flat-type non-aqueous electrolytic solution battery according to an embodiment;

FIGS. 2A to 2C are perspective views showing the flat-type non-aqueous electrolytic solution battery according to an embodiment mounted on a substrate;

FIGS. 3A to 3C are sectional views showing the flat-type non-aqueous electrolytic solution battery according to an embodiment mounted on the substrate;

FIG. 4 is a schematic view showing a spray dryer for producing a positive electrode mixture contained in the flat-type non-aqueous electrolytic solution battery according to an embodiment;

FIG. 5 is a sectional view showing a flat-type non-aqueous electrolytic solution battery according to an embodiment;

FIG. 6 is a graph showing an X-ray diffraction spectrum of the positive electrode mixture of Example 1-1;

FIG. 7 is an enlarged view of a portion A in the vicinity of 41.3° in FIG. 6; and

FIG. 8 is a graph showing the X-ray diffraction spectrum of the positive electrode mixture of Examples 1-4 to 1-6.

### DETAILED DESCRIPTION

The present disclosure will be described below in further detail according to an embodiment. While the description is made with reference to the drawings as necessary, the contents shown in the drawings are only schematically and illustratively shown for understanding the present disclosure, and the appearance, the dimensional ratio, and the like can be different from the actual ones.

The various numerical ranges referred to herein are intended to include the lower limit and upper limit numerical values themselves, for example, unless otherwise noted, such as “less than”, “smaller than”, and “greater than”. That is, taking a numerical range such as 1 to 10 as an example, it is interpreted as including both the lower limit value “1” and the upper limit value “10.”

One numerical range (for example, 1 or more) selected from a plurality of numerical ranges (for example, 1 or more and 10 or more) described only with the lower limit value and one numerical range (for example, 100 or less) selected from a plurality of numerical ranges (for example, 100 or less and 20 or less) described only with the upper limit value may be combined (for example, 1 or more and 100 or less).

In the present disclosure, the “battery” refers to a device capable of extracting energy by utilizing an electrochemical reaction in a broad sense and refers to a device that includes a pair of electrodes and an electrolyte and is particularly discharged with the migration of ions in a narrow sense.

A battery according to an embodiment is a flat-type lithium manganese dioxide primary battery (CR battery) including manganese dioxide (manganese dioxide electrode) as a positive electrode, lithium (lithium electrode) as a negative electrode, and a non-aqueous electrolytic solution containing a lithium salt as an electrolytic solution. The flat type refers to a shape recognized by those skilled in the art as a flat type (flat shape), is, for example, a flat substantially cylindrical shape or a substantially polygonal column (more specifically, substantially quadrangular prism), and is preferably a cylindrical shape (more specifically, coin type) in which an outer diameter (r) of a circle is larger than a height (h) in plan view (that is, an aspect ratio h/r is smaller than 1), or a polygonal column shape in which a longest diagonal line (1) of a polygon is larger than the height (h) (that is, an aspect ratio 1/r is smaller than 1). Here, the substantially cylinder is not limited to a strict cylinder (more specifically, true cylinder), and includes a substantial cylinder (more specifically, an elliptic cylinder or the like) in consideration of substantial variation and the like. The substantially polygonal column is not limited to a strict polygonal column (more specifically, regular polygonal prism or the like), and includes a substantial polygonal column (more specifically, chamfered polygonal column, and the like) in consideration of practical variations and the like. The longest diagonal of the polygon refers to the longest diagonal among a plurality of diagonals in the diagonal.

The “manganese dioxide electrode” herein refers to a positive electrode containing manganese dioxide as a positive electrode active material (positive electrode active material).

The “lithium electrode” herein refers to a negative electrode containing a lithium element as a negative electrode active material (negative electrode active material). Examples of an aspect of lithium contained in the lithium electrode as a constituent element include metal lithium, a lithium alloy, and a lithium compound.

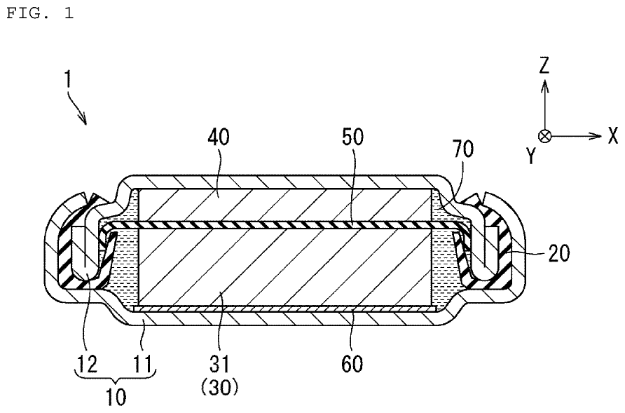

Hereinafter, a flat-type non-aqueous electrolytic solution battery according to an embodiment will be described with reference to FIG. 1. FIG. 1 is a sectional view showing the flat-type non-aqueous electrolytic solution battery according to an embodiment.

A flat-type non-aqueous electrolytic solution battery (hereinafter, also simply referred to as a “battery”) 1 according to an embodiment includes a positive electrode 30 containing manganese dioxide (containing a positive electrode mixture 31), a negative electrode 40 containing a lithium element, and a non-aqueous electrolytic solution (hereinafter, also simply referred to as an “electrolytic solution”) 70, and in an X-ray photoelectron spectroscopy (XPS) spectrum of the positive electrode mixture 31, a peak intensity ratio I₂/I₁ of Mn2p_{3/2} satisfies the following formula (1):

$$\begin{matrix}[ Math . 2 ] & \\ 0.3 ≦ \frac{{I}_{2}}{{I}_{1}} ≦ 0.55 & ( 1 )\end{matrix}$$

[in the formula (1), I₁ represents a peak intensity at a binding energy of 642 eV, and I₂ represents a peak intensity at a binding energy of 640 eV].

The peak intensity ratio I₂/I₁ of Mn2p₃₁₂ in the XPS spectrum of the positive electrode mixture 31 can be determined as follows.

The XPS spectrum of the positive electrode mixture 31 is measured using a scanning X-ray photoelectron spectrometer (“Quantera-SXM” manufactured by ULVAC-PHI, INCORPORATED.). From the obtained XPS spectrum, the peak intensity I₁ at a binding energy of 642 eV and the peak intensity I₂ at a binding energy of 640 eV are measured. Here, the peak intensity is a peak maximum value (not an integrated value of peaks). The peak intensity ratio I₂/I₁ is calculated from the obtained I₁ and I₂. Details will be described in Examples.

The positive electrode mixture 31 to be measured by the method of determining the peak intensity ratio I₂/I₁ may be the positive electrode mixture 31 prepared in a method of manufacturing the battery 1, or may be the positive electrode mixture 31 taken out by disassembling the battery 1 (as a finished product).

The peak having a binding energy of 642 eV in the XPS spectrum is assigned to Mn⁴⁺, and the peak having a binding energy of 640 eV is assigned to Mn²⁺. Mn⁴⁺ is Mn⁴⁺ in manganese dioxide MnO₂ constituting the positive electrode mixture 31, and Mn²⁺ is Mn²⁺ of a reduced product (for example, MnO) of MnO₂ constituting the positive electrode mixture 31. Thus, the peak intensity ratio I₂/I₁ of the positive electrode mixture 31 indicates a composition (that is, a molar ratio of a reduced product of MnO₂ to MnO₂) in (the vicinity of the surface of) the positive electrode mixture 31. Here, the vicinity of the surface refers to a range (more specifically, in a range of 0 nm or more and 10 nm or less,) from an outermost surface of the positive electrode mixture 31 to 10 nm in a depth direction in the present specification. Here, the depth direction refers to a direction perpendicular to a surface of the target positive electrode mixture 31 and directed from the surface toward the inside of the positive electrode mixture 31.

More specifically, the peak intensity ratio I₂/I₁ of the positive electrode mixture 31 indicates a molar ratio of MnO to MnO₂ in the vicinity of the surface of the positive electrode mixture 31. That is, the lower limit value of the peak intensity ratio I₂/I₁ in the formula (1) indicates a minimum molar ratio at which MnO is present in the vicinity of the surface of the positive electrode mixture 31 (that is, a maximum molar ratio at which MnO₂ is present in the vicinity of the surface of the positive electrode mixture 31). On the other hand, the upper limit value of the peak intensity ratio I₂/I₁ in the formula (1) indicates a maximum molar ratio at which MnO is present in the vicinity of the surface of the positive electrode mixture 31 (that is, a minimum molar ratio at which MnO₂ is present in the vicinity of the surface of the positive electrode mixture 31).

The battery 1 according to an embodiment is excellent in heat resistance. Although not bound by a specific theory, the reason is presumed as follows. Since manganese dioxide has an oxidizing action, usually, when an electrolytic solution comes into contact with a positive electrode containing manganese dioxide (including a positive electrode mixture) (more specifically, when the electrolytic solution comes into contact with a surface of manganese dioxide particles contained in the positive electrode 30), the electrolytic solution is oxidized, carbon dioxide is generated, and the battery may be deformed. On the other hand, in the battery 1 according to an embodiment, the peak intensity ratio I₂/I₁ is 0.30 or more. In this case, an MnO₂ reductant (for example, MnO) is present at a constant ratio in the vicinity of the surface of the positive electrode mixture 31. Thus, oxidation of an electrolytic solution 70 is suppressed on the surface (more specifically, surfaces of positive electrode active material particles (manganese dioxide particles) in the positive electrode 30 in contact with the electrolytic solution 70) of the positive electrode 30 (positive electrode mixture 31) in contact with the electrolytic solution 70. Thus, the non-aqueous electrolytic solution battery 1 according to an embodiment suppresses generation of carbon dioxide and suppresses deformation of the battery 1 under a high-temperature environment (for example, under a temperature environment of 260° C.). Thus, the battery 1 according to an embodiment is excellent in heat resistance.

The peak intensity ratio I₂/I₁ is preferably 0.40 or more, 0.45 or more, or 0.50 or more from the viewpoint of improving the heat resistance of the battery 1. On the other hand, the peak intensity ratio I₂/I₁ is preferably 0.50 or less, 0.45 or less, or 0.40 or less from the viewpoint of improving the discharge capacity of the battery 1.

The present inventors have focused, for example, on the fact that expansion of a battery under a high-temperature environment (for example, under an environment of 150° C. or higher) is oxidized by contact of a solvent of an electrolytic solution with a positive electrode (including a positive electrode mixture) containing manganese dioxide having an oxidizing action, and as a result, carbon dioxide is generated. Based on the mechanism of occurrence of such a problem, the present inventors have developed, for example, a technique of reducing the oxidation action (more specifically, the oxidation action on the surface of the positive electrode active material (manganese dioxide) particles) of the surface of the positive electrode with which the electrolytic solution frequently comes into contact in order to suppress the generation of carbon dioxide. Based on such, by reducing a part of the positive electrode active material (manganese dioxide) on the surface of the positive electrode 30 (positive electrode mixture 31) (more specifically, by reducing a part of the surface of the positive electrode active material (manganese dioxide) particles in the positive electrode 30), the heat resistance under a high-temperature environment is improved without impairing the original function of the battery 1 according to an embodiment.

The battery 1 according to the present disclosure is excellent in heat resistance under a high-temperature environment (for example, under a high-temperature environment at 150° C. or higher). For example, the battery 1 can be used because swelling of the battery 1 can be effectively suppressed under a high-temperature environment (for example, the temperature is 150° C. and the heating time is 100 hours).

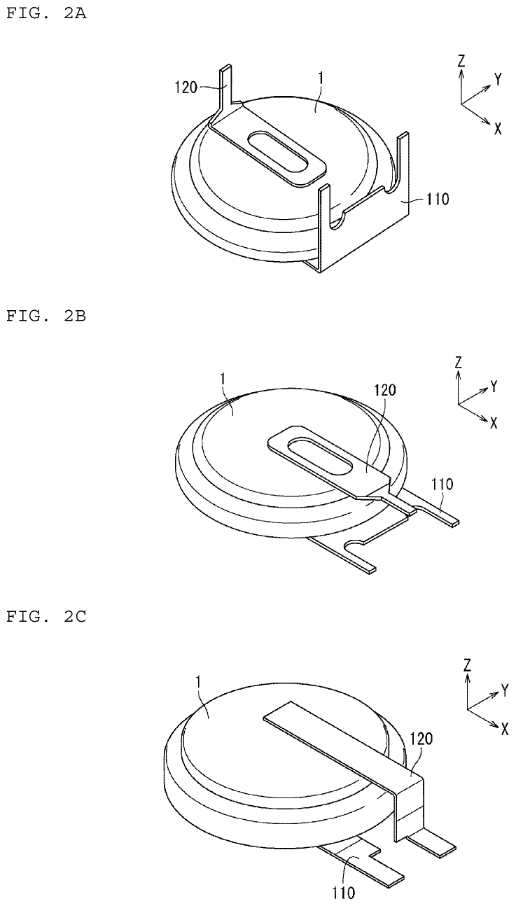

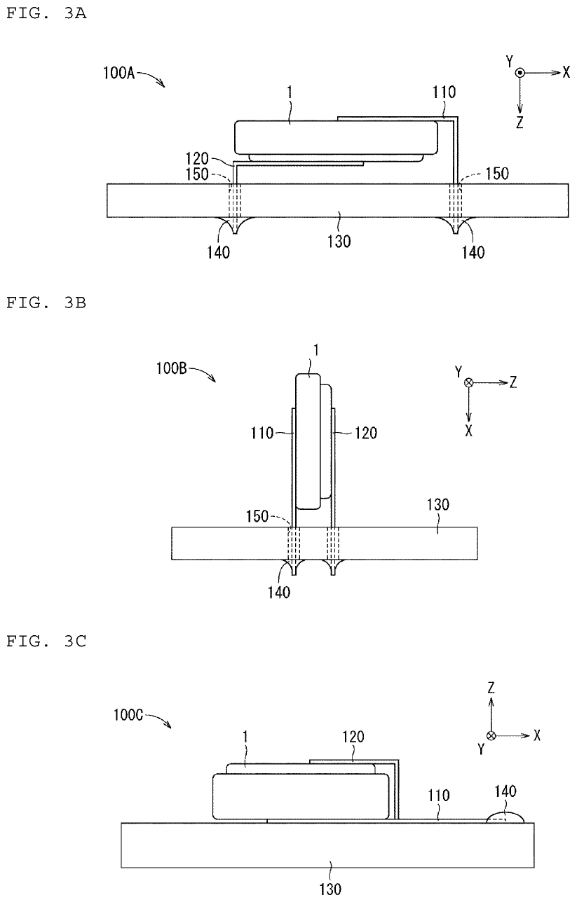

The battery 1 can effectively suppress the swelling of the battery 1 in a reflow environment (for example, the temperature is 260° C. and the heating time is 5 minutes) in board mounting. Thus, the battery 1 can be mounted on the substrate by reflow soldering. The battery 1 is particularly useful for board mounting by reflow soldering. Mounting of the battery 1 on the substrate will be described with reference to FIGS. 2 and 3. FIGS. 2 and 3 are a perspective view and a sectional view showing the battery 1 mounted on the substrate, respectively. FIGS. 2(A) to 2(C) correspond to FIGS. 3(A) to 3(C), respectively. In FIG. 2, the mounting substrate and the solder are omitted for convenience.

The battery 1 is particularly useful in an application as a power source of a tire mounted sensor directly attached to an inner liner of a vehicle tire. This is because it is possible to effectively suppress the swelling of the battery 1 in a high-temperature environment more severe than a use as a power source of a sensor (Tire Pressure Monitoring System) built in a tire valve.

As shown in FIGS. 2(A) and 3(A), the battery 1 can be mounted on a substrate 130 via a connection terminal (positive electrode connection terminal 110, negative electrode connection terminal 120). A part of the connection terminals 110 and 120 is inserted into the through hole 150 of the substrate 130 and fixed with the solder 140, and is electrically connected to a circuit of the substrate 130. The connection terminals 110 and 120 may be L-shaped in a ZX sectional view, or may be linear in the ZX sectional view as shown in FIGS. 2(B) and 3(B). In addition, as shown in FIGS. 2(C) and 3(C), a part of the connection terminals 110 and 120 may be placed on a circuit (not shown) on the substrate 130 and soldered to the substrate 130. In this way, mounting boards 100A, 100B, and 100C are produced.

In a preferred aspect, the battery 1 satisfies the following condition, and in this case, heat resistance is further excellent. The positive electrode mixture 31 has a diffraction peak of a (200) plane shifted to a low angle side of a diffraction angle 2θ=41.3°±0.1° in an X-ray diffraction spectrum obtained by X-ray diffraction measurement using a CuKα ray as an X-ray source.

The diffraction peak in the X-ray diffraction spectrum can be confirmed as follows. The X-ray diffraction spectrum of the positive electrode mixture 31 is measured using an X-ray diffractometer (“Ultima-IV” manufactured by Rigaku Corporation). From the obtained X-ray diffraction spectrum, the presence or absence of the diffraction peak located on the low angle side at a diffraction angle 2θ=41.3°+0.1° is confirmed. Details will be described in Examples. The positive electrode mixture 31 to be measured in the confirmation of the diffraction peak may be the positive electrode mixture 31 (more specifically, the positive electrode mixture 31 molded into a pellet shape) prepared in the method of manufacturing the battery 1, or may be the positive electrode mixture 31 (more specifically, the positive electrode mixture 31 in a pellet form) taken out by disassembling the battery 1 (as a finished product).

A peak located at a diffraction angle 2θ=41.3°±0.1° in an X-ray diffraction spectrum is assigned to MnO₄, and a peak located one the low angle side at a diffraction angle 2θ=41.3°+0.1° is assigned to a reduced product of MnO₄ (for example, MnO). From the X-ray diffraction spectrum, the presence of the diffraction peak located on the low angle side at a diffraction angle 2θ=41.3°+0.1° (that is, the diffraction peak shift) suggests the presence of a reduced product of MnO₂ in (the vicinity of the surface of) the positive electrode mixture 31. Here, the vicinity of the surface is synonymous with the vicinity of the surface described above with the peak intensity ratio I₂/I₁.

As shown in FIG. 1, the battery 1 includes the positive electrode 30 (positive electrode mixture 31), the negative electrode 40 disposed to face the positive electrode 30 with a separator 50 interposed therebetween, a battery can 10 that houses the positive electrode 30, the negative electrode 40, and the separator 50, and the electrolytic solution 70 sealed in the battery can 10. The battery can 10 includes a positive electrode container 11 that houses the positive electrode 30, and a negative electrode container 12 that is disposed via a gasket 20 electrically insulated from the positive electrode container 11 and houses the negative electrode 40. The battery 1 further includes a positive electrode conductive layer 60 interposed between the positive electrode container 11 and the positive electrode 30.

Hereinafter, members in the battery 1 will be described. In FIG. 1, a stacking direction of the positive electrode 30 and the negative electrode 40 is defined as a Z direction, a direction perpendicular to the Z direction and parallel to a paper surface is defined as an X direction, and a direction perpendicular to the Z direction and perpendicular to the paper surface is defined as a Y direction. In addition, an upward direction in the paper surface is defined as a forward Z direction, and a downward direction in the paper surface is defined as a reverse Z direction.

The battery can 10 is a storage member (housing member) that stores (houses) the positive electrode 30, the negative electrode 40, the separator 50, and the like. The battery can 10 includes a pair of vessel-shaped members (positive electrode container 11 and negative electrode container 12) having one end portion opened and the other end portion closed. Specifically, the battery can 10 includes the positive electrode container 11 that houses the positive electrode 30 and the negative electrode container 12 that houses the negative electrode 40. The positive electrode container 11 and the negative electrode container 12 are engaged with each other via the gasket 20 which electrically insulates the positive electrode container and the negative electrode container from each other such that one end portions of the positive electrode container and the negative electrode container face each other.

The positive electrode container 11 is a positive electrode storage member that stores the positive electrode 30 (positive electrode mixture 31) (more specifically, the positive electrode 30 (positive electrode mixture 31) molded into a pellet shape). The positive electrode container 11 has a substantially cylindrical shape, and has a substantially circular bottom surface (in XY sectional view), a substantially circular positive electrode opening portion facing the bottom surface (in XY sectional view), and a side wall surface (side surface) connected between the bottom surface and the positive electrode opening portion. Since the positive electrode container 11 is indirectly connected to the positive electrode 30 via the positive electrode conductive layer 60, the positive electrode container also serves as a current collector of the positive electrode 30 and also serves as a terminal for external connection of the positive electrode 30 (so-called positive electrode terminal).

The positive electrode container 11 contains, for example, a conductive material such as a metal material. Examples of the metal material include an iron material and stainless steel. Among them, stainless steel is preferable as the metal material from the viewpoint of corrosion resistance. Examples of the stainless steel include SUS 316, SUS 430, and SUS 444. The positive electrode container 11 may contain one of the above-described conductive materials alone, or may contain two or more thereof (combination thereof). The positive electrode container 11 may be configured of a single layer, or may be configured of multiple layers. When the positive electrode container 11 has multiple layers, for example, each layer may contain a different conductive material, or the surface of the positive electrode container 11 may be subjected to plating treatment.

The negative electrode container 12 is a negative electrode storage member that storages the negative electrode 40. Similarly to the positive electrode container 11, the negative electrode container 12 has a substantially cylindrical shape, and has a substantially circular bottom surface (in XY sectional view), a substantially circular negative electrode opening portion facing the bottom surface (in XY sectional view), and a side wall surface (side surface) connected between the bottom surface and the positive electrode opening portion. Since the negative electrode container 12 is connected to the negative electrode 40, the negative electrode container also serves as a current collector of the negative electrode 40 and also serves as a terminal for external connection of the negative electrode 40 (so-called negative electrode terminal).

The negative electrode container 12 contains, for example, a conductive material such as a metal material. Examples of the metal material include an iron material and stainless steel. The metal material of the negative electrode container 12 is synonymous with the metal material of the positive electrode container 11.

The negative electrode container 12 is engaged with the positive electrode container 11 via the gasket 20. An outer diameter of the negative electrode opening portion of the negative electrode container 12 is smaller than an inner diameter of the positive electrode opening portion of the positive electrode container 11. As a result, the side wall surface of the negative electrode container 12 is inserted into the positive electrode container 11 such that the negative electrode opening portion faces the positive electrode opening portion, and in this state, the negative electrode container 12 is engaged with the positive electrode container 11. As shown in FIG. 1, in the ZX sectional view, an end portion (peripheral edge portion) of the negative electrode container 12 is folded back in the forward Z direction.

The battery 1 further includes the gasket 20. The gasket 20 is a ring-shaped sealing member for sealing a gap between the positive electrode container 11 and the negative electrode container 12. The gasket 20 is interposed between the positive electrode container 11 and the negative electrode container 12, and electrically insulates the positive electrode container 11 and the negative electrode container 12 from each other.

The gasket 20 contains, for example, a polymer. Examples of the polymer include thermoplastic resins. Examples of the thermoplastic resin include fluororesins (more specifically, perfluoroalkoxy alkane (PFA), polytetrafluoroethylene (PTFE), and the like), polypropylene (PP), polybutylene terephthalate (PBT), polyphenylene ether (PEE), polysulfone (PSF), polysulfone (PSF), polyarate (PAR), polyethersulfone (PES), polyphenylene sulfide (PPS), polyetheretherketone (PEEK), and polyetherimide (PEI). The polymer may contain one of the above resins alone, or may contain two or more thereof (combination thereof). Among them, the polymer preferably contains PPS, PBT and PEI from the viewpoint of improving sealing performance under a high-temperature environment and mass productivity (moldability) of the gasket 20, and more preferably contains PPS from the viewpoint of improving moisture permeation resistance. The resin constituting the gasket can be identified by Fourier transform infrared analysis (FT-IR analysis), similarly to a positive electrode binder described later.

From the viewpoint of improving sealability of the battery 1, at least a part of the gasket 20 may be covered with a sealant (not shown). That is, the battery 1 may further include a sealant for covering at least a part of the gasket 20 from the viewpoint of improving the sealability of the battery 1. Examples of the sealant include polyisobutylene. The sealant may contain polyisobutylene as a main component (95% by mass or more, 95% by mass or more, 98% by mass or more, or 100% by mass with respect to 100% by mass of the sealant).

The positive electrode 30 is the positive electrode mixture 31 having a flat shape. In the positive electrode mixture 31, as described above, in the X-ray photoelectron spectroscopy (XPS) spectrum, the peak intensity ratio I₂/1₁ of Mn2p_{3/2} satisfies the formula (1). That is, a part of the positive electrode mixture 31 is reduced in the vicinity of a surface of a flat pellet. Such a method of producing the positive electrode mixture 31 in which a part is reduced will be described later.

A specific surface area of the positive electrode mixture 31 is preferably 10.3 m²/g or more and 28.0 m²/g or less from the viewpoint of imparting a good open circuit voltage (OCV) to the battery 1 while maintaining excellent heat resistance. The specific surface area of the positive electrode mixture 31 is determined using a specific surface area/pore distribution measuring device (“BELSORP⋅MINI” manufactured by MicrotracBEL Corp.). Details will be described in Examples. The specific surface area of the positive electrode mixture 31 can be adjusted by, for example, the particle size and the specific surface area of manganese dioxide at a raw material stage, the particle size of reduced manganese dioxide particles, the applied pressure in molding of the positive electrode mixture 31, the content of the positive electrode binder and a positive electrode conductive agent, and the like.

The positive electrode 30 contains a positive electrode active material, and may further contain a positive electrode binder, a positive electrode conductive agent, and the like. The positive electrode active material is a manganese dioxide electrode containing manganese dioxide (MnO₂). The battery 1 including the positive electrode 30 containing manganese dioxide as the positive electrode active material has a higher working voltage than a battery including a positive electrode containing iron sulfide, copper oxide, and the like as the positive electrode active material. In addition, the battery 1 including the positive electrode 30 containing manganese dioxide (containing the positive electrode mixture 31) as the positive electrode active material has substantially the same range of working voltage and high load characteristics as compared with a battery including a positive electrode containing graphite fluoride as the positive electrode active material.

In one aspect, the positive electrode 30 can have a structure in which a plurality of positive electrode active material particles are aggregated (aggregated structure of positive electrode active material particles). When the positive electrode 30 has the aggregated structure of the plurality of positive electrode active material particles, the positive electrode 30 may have a void from a microscopic viewpoint. In such a case, in the battery 1, since the electrolytic solution 70 can enter and fill a void between the positive electrode active material particles, the electrolytic solution 70 comes into contact with the positive electrode active material with a relatively large contact area. In such a case, the electrolytic solution 70 is usually susceptible to the oxidation action of the positive electrode active material; however, in the present embodiment, a part of the surface of the positive electrode active material (manganese dioxide) particles is reduced to reduce the oxidation action. Thus, when the positive electrode 30 has the aggregated structure of the plurality of positive electrode active material particles, the electrolytic solution 70 is less likely to be oxidized and is more excellent in heat resistance.

The positive electrode active material may contain two or more kinds of manganese dioxide having crystallinity different from each other. Examples of the manganese dioxide include α-MnO₂, β-MnO₂, γ-MnO₂, and ε-MnO₂. The manganese dioxide preferably contains β-MnO₂ from the viewpoint of improving a theoretical capacity of the battery 1. β-MnO₂ is preferably not chemically synthesized but electrolytic manganese dioxide calcined in a range of 350° C. to 480° C. in consideration of marketability and the like. The manganese dioxide may contain Mn₂O₃, Mn₃O₄, and the like as impurities.

The content of manganese dioxide is preferably 80% by mass or more and 94% by mass or less with respect to 100% by mass of the positive electrode mixture 31. When the content of manganese dioxide is 80% by mass or more and 94% by mass or less, the occurrence of cracking of the positive electrode mixture 31 can be suppressed while maintaining a constant discharge capacity.

The content of manganese dioxide can be determined as follows. Specifically, the battery 1 is disassembled, and the positive electrode mixture 31 is taken out. The positive electrode mixture 31 taken out is washed with pure water, and then the mass (initial positive electrode mixture mass) is measured. Manganese dioxide is removed from the positive electrode mixture 31 by acid washing. The mass after removal (mass of the positive electrode mixture after removal) is measured. The content of manganese dioxide is calculated from the mass of the positive electrode mixture before and after removal of manganese dioxide.

The positive electrode active material may be particulate. In this case, the positive electrode 30 is molded (into a pellet shape) by compressing a particulate positive electrode active material and other components (more specifically, a positive electrode binder, a positive electrode conductive agent, and the like) as necessary. When the positive electrode active material is particulate, the particle size is preferably 10 to 500 μm.

The positive electrode binder bonds components constituting the positive electrode 30. The positive electrode 30 preferably contains the positive electrode binder from the viewpoint of further securing the moldability of the positive electrode 30. The positive electrode binder preferably contains a polymer. Examples of the polymer include fluororesins (more specifically, polytetrafluoroethylene, polyvinylidene fluoride, and the like). The positive electrode binder may contain one of these polymers alone or two or more thereof. The content of the positive electrode binder is preferably 1.0% by mass or more and less than 3.0% by mass with respect to 100% by mass of the positive electrode mixture 31 from the viewpoint of improving mechanical strength and the like while suppressing a decrease in the discharge capacity of the battery 1.

The positive electrode binder can be identified by Fourier transform infrared analysis (FT-IR analysis). Specifically, the battery 1 is disassembled, and the positive electrode mixture 31 is taken out. The taken out positive electrode mixture 31 is washed with a washing solvent (for example, dimethoxyethane (DME)), and then immersed in a solvent (for example, dimethylformamide (DMF)) to be dissolved. The obtained solution is dried to obtain a solid component. The solid component is subjected to FT-IR analysis using a Fourier transform infrared spectrometer (“Nicolet 6700” manufactured by Thermo Fisher Scientific Inc.).

The positive electrode conductive agent improves the conductivity of the positive electrode 30. The positive electrode 30 preferably contains a positive electrode conductive agent from the viewpoint of improving the conductivity thereof. The positive electrode conductive agent contains, for example, a conductive material such as a carbon material. Examples of the carbon material include carbon black, graphite, graphene, and carbon fiber (more specifically, gas phase method carbon fiber (VGCF) and the like). From the viewpoint of achieving both the moldability and the liquid retaining property of the pellet shape of the positive electrode mixture 31, the carbon material preferably contains graphite or carbon black among these materials. The positive electrode conductive agent may contain one of these conductive materials alone or two or more of these conductive materials.

When the positive electrode 30 contains the positive electrode conductive agent (carbon material), a mixing ratio (positive electrode active material:positive electrode conductive agent) (mass ratio) of the positive electrode active material (manganese dioxide) and the positive electrode conductive agent is preferably 90:10 to 97:3 from the viewpoint of obtaining excellent pulse discharge characteristics in the order of several tens of mA while securing electrical characteristics such as battery capacity. When the positive electrode 30 contains the positive electrode conductive agent (carbon material), the content of the positive electrode conductive agent is preferably 0.5 to 4% by mass in carbon black (CB) with respect to 100% by mass of the positive electrode 30 from the viewpoint of improving the discharge capacity, and is preferably 4% by mass or more from the viewpoint of increasing a liquid absorption amount of the positive electrode 30 while suppressing a swelling amount of the positive electrode 30. The content of the positive electrode conductive agent in graphite is, for example, 1.0 to 9.0% by mass with respect to 100% by mass of the positive electrode 30, and is preferably 3.0 to 7.0% by mass from the viewpoint of improving the discharge capacity, and the content of the positive electrode conductive agent in graphite is preferably 6.0 to 21.0% by mass with respect to 100% by mass of the positive electrode 30 from the viewpoint of suppressing the occurrence of cracking of the positive electrode 30.

A method of calculating the content of the positive electrode conductive agent is as follows. In the method of measuring the content of manganese dioxide described above, the positive electrode mixture 31 (that is, the solid content) from which manganese dioxide is taken out is sufficiently washed with pure water and then dried. The obtained dried product is subjected to simultaneous thermogravimetry and differential thermal analysis (TG-DTA) using a simultaneous thermogravimetry-differential thermal analyzer (“TG/DTA 6300” manufactured by SII Nanotechnology). In this measurement, the following temperature profile is used.

### —Temperature Profile—

(1) Heating: Room temperature (25° C.)!650° C. (temperature raising rate: +10° C./min, under nitrogen atmosphere, flow rate: 300 mL/min)
(2) Retention: 650° C. (10 min, under nitrogen atmosphere: flow rate 300 mL/min)
(3) Cooling: 650° C. !200° C. (temperature lowering rate: −22.5° C./min, under nitrogen atmosphere, flow rate: 300 mL/min)
(4) Retention: 200° C. (10 min, under argon atmosphere: flow rate 300 mL/min)
(5) Heating: 200° C. !1000° C. (temperature raising rate: +10° C./min, under argon atmosphere, flow rate: 300 mL/min)

### [Negative Electrode]

The negative electrode 40 is a flat lithium electrode. The negative electrode 40 and the positive electrode 30 face each other with the separator 50 interposed therebetween. The negative electrode 40 contains a negative electrode active material and may further contain a negative electrode binder. The negative electrode active material contains a lithium-based material. The battery 1 including the negative electrode 40 containing a lithium-based material as the negative electrode active material has a higher mass energy density than a battery including a negative electrode containing the negative electrode active material other than the lithium-based material, and thus has a high capacity. The lithium-based material contains lithium as a constituent element.

In other words, the negative electrode 40 contains a lithium element. The negative electrode 40 containing a lithium element means that the negative electrode 40 is composed of a chemical species containing a lithium element. The negative electrode 40 may be configured not only in a form containing only the lithium element itself (lithium metal) but also in a form containing the lithium element as a part thereof (lithium alloy and lithium compound).

Examples of the lithium-based material include metal lithium (lithium simple substance), a lithium alloy (more specifically, a lithium aluminum alloy, a lithium tin alloy, a lithium carbon alloy, a lithium silicon alloy, a lithium nickel alloy, and the like), and a lithium compound (more specifically, LiC₆ and the like). The negative electrode active material may contain one of these lithium-based materials alone, or may contain two or more thereof. That is, the negative electrode 40 may contain at least one selected from the group consisting of metal lithium, a lithium alloy, and a lithium compound. The negative electrode active material preferably contains two or more kinds of lithium-based materials from the viewpoint of improving large current characteristics of the battery 1 under a low-temperature environment (for example, under a −40° C. environment).

When the negative electrode active material contains a lithium compound as a lithium-based material, the negative electrode 40 may be a flat pellet. The flat pellet may be a molded negative electrode mixture. In this case, the negative electrode 40 may contain a negative electrode binder. The negative electrode binder bonds components constituting the negative electrode 40. The type of the negative electrode binder is the same as the type of the positive electrode binder.

The battery 1 further includes the separator 50 between the positive electrode mixture 31 and the negative electrode 40. The separator 50 is interposed between the positive electrode 30 and the negative electrode 40 to electrically insulate the positive electrode 30 and the negative electrode 40 from each other. The separator 50 includes, for example, at least one of a porous membrane and a nonwoven fabric. The porous membrane and the nonwoven fabric each independently contain at least one polymer selected from the group consisting of polyethylene, polypropylene, methylpentene polymer, polybutylene terephthalate, and polyphenylene sulfide. The separator 50 contains, for example, an inorganic material of at least one of glass fiber and ceramic.

In a preferred aspect, the separator 50 preferably contains polyphenylene sulfite having a melting point higher than 260° C. from the viewpoint of effectively preventing an internal short circuit of the battery 1 used under a high-temperature environment (under a 260° C. environment).

In a preferred aspect, the separator 50 includes a nonwoven fabric from the viewpoint of improving a liquid absorbing property of the electrolytic solution 70 by the separator 50. In a more preferred aspect, a basis weight of the nonwoven fabric is 10 g/m² to 100 g/m² and the thickness of the nonwoven fabric is 80 μm to 500 μm. In a more preferred aspect, the occurrence of an internal short circuit in the primary battery after storage at a high temperature is suppressed while the liquid absorbing property of the electrolytic solution by the separator 50 is improved.

The separator 50 may have a single layer or multilayer layers. The separator 50 may have a layer composed of a surfactant or the like on the surface thereof.

### [Positive Electrode Conductive Layer]

The positive electrode conductive layer 60 is interposed between the positive electrode container 11 and the positive electrode 30. When the battery 1 includes the positive electrode conductive layer 60, the internal resistance of the battery 1 decreases, and discharge performance under various conditions in the (primary) battery is improved. The positive electrode conductive layer 60 contains a powdery conductive material (a plurality of conductive particles and conductive powder). Examples of the conductive material include silver, a lithium aluminum alloy, and a carbon material. The positive electrode conductive layer 60 may be composed of one of these conductive materials alone, or may be composed of two or more of these conductive materials.

The electrolytic solution 70 is a non-aqueous electrolytic solution containing a non-aqueous solvent. Each of the positive electrode 30, the negative electrode 40, and the separator 50 is impregnated with the electrolytic solution 70. The electrolytic solution may be further present in a space around the positive electrode 30, the negative electrode 40, the separator 50, and the like in the battery can 10.

The mass ratio W₁/W₂ of the electrolytic solution 70 to the positive electrode mixture 31 satisfies the following formula (2):

$$\begin{matrix}[ Math . 3 ] & \\ 0.2 ≦ \frac{{W}_{2}}{{W}_{1}} ≦ 0.23 & ( 2 )\end{matrix}$$

[in the formula (2), W₂ (g) represents the mass of the positive electrode mixture 31, and W₁ (g) represents the mass of the electrolytic solution 70]. When the mass ratio W₁/W₂ satisfies the formula (2), discharge based on the International Electrotechnical Commission (IEC) can also be achieved while maintaining a constant discharge capacity under a high-temperature environment (260° C. for 5 minutes). A method of calculating the mass ratio W₁/W₂ will be described in detail in Examples.

The electrolytic solution 70 contains, for example, an anhydrous dicarboxylic acid compound, an electrolyte salt, and a non-aqueous solvent. The electrolytic solution 70 may further contain an alkali metal compound. Hereinafter, each component of the electrolytic solution will be described.

The electrolytic solution 70 is in contact with the positive electrode 30 (positive electrode mixture 31) in the battery 1. For example, the electrolytic solution 70 can enter not only the surface of the positive electrode 30 but also gaps (of an aggregate) of a plurality of positive electrode active material (manganese dioxide) particles constituting the positive electrode 30 and can penetrate into the positive electrode 30. As described above, the electrolytic solution 70 can be in contact with the surfaces of a plurality of positive electrode active materials constituting the positive electrode 30.

Since the dicarboxylic anhydride compound forms a film on the positive electrode 30 (positive electrode mixture 31) and reduces a part of manganese dioxide (in particular, manganese dioxide on the surface of the positive electrode 30 (positive electrode mixture 31)) on the surface of the positive electrode 30 (positive electrode mixture 31), a decomposition reaction of the electrolytic solution is suppressed on the surface of the positive electrode 30 (more specifically, on the surface of the manganese dioxide particles). Since divalent manganese (Mn²⁺) is increased by XPS analysis, it is presumed that manganese oxide (MnO) is generated by reduction of manganese dioxide.

The electrolytic solution 70 may contain a dicarboxylic anhydride compound (hereinafter, also referred to as “dicarboxylic anhydride compound (1)”) represented by the general formula (1):

[Chem. 1]

W(—C(═0)—0—C(═0)—)z . . . (1)

[in the general formula (1), W represents a benzene-based aromatic ring from which 2z hydrogens have been eliminated, and z represents an integer of 2 or more].

The dicarboxylic anhydride compound (1) is a compound containing a benzene-based aromatic ring (W) from which 2z hydrogens have been eliminated and z dicarboxylic anhydride groups (—C(═O)—O—C(═O)—) as shown in the general formula (1). The number of types of the dicarboxylic anhydride compounds may be only one, or two or more. That is, the dicarboxylic anhydride compound (1) is a compound in which z divalent dicarboxylic anhydride compound groups are introduced into a benzene-based aromatic ring, in other words, a compound in which 2z hydrogens of the benzene-based aromatic ring are substituted with z dicarboxylic anhydride groups.

In the general formula (1), the benzene-based aromatic ring (W) is an aromatic ring including one or more benzene rings. The aromatic ring containing one benzene ring is a benzene ring. The aromatic ring including two or more benzene rings is an aromatic ring in which the two or more benzene rings are fused, and examples thereof include a naphthalene ring, an anthracene ring, and a phenanthrene ring.

In the general formula (1), the dicarboxylic anhydride group (—C(═O)—O—C(═O)—) is bonded to two carbon atoms among ring member atoms (carbon atoms) constituting the benzene-based aromatic ring. The two carbon atoms may or may not be adjacent in the benzene-based aromatic ring. When two carbon atoms are not adjacent in the benzene-based aromatic ring, the two carbon atoms are separated via one or two or more ring member atoms (carbon atoms).

In the general formula (1), z represents an integer of 2 or more. That is, two or more dicarboxylic anhydride groups are substituted with a benzene-based aromatic ring. When two or more dicarboxylic anhydride groups are substituted with the benzene-based aromatic ring (in the general formula (1), when z represents an integer of 2 or more), the progress of the decomposition reaction of the electrolytic solution on the surface of the positive electrode 30 containing manganese dioxide can be sufficiently suppressed.

Examples of the dicarboxylic anhydride (1) include pyromellitic anhydride (z represents 2, and the benzene-based aromatic ring represents a benzene ring) and mellitic anhydride (z represents 3, and the benzene-based aromatic ring represents a benzene ring). When the dicarboxylic anhydride (1) is at least one of pyromellitic anhydride and mellitic anhydride, it is possible to suppress an increase in electric resistance of the positive electrode 30 while suppressing the decomposition reaction of the electrolytic solution on the surface of the positive electrode 30.

The content of the dicarboxylic anhydride compound is preferably 1% by mass to 5.0% by mass with respect to 100% by mass of the electrolytic solution 70 from the viewpoint of suppressing the decomposition reaction of the electrolytic solution 70 by the reduction reaction and stabilizing the open circuit voltage (OCV).

The electrolytic solution 70 contains a lithium salt as an electrolyte salt. Examples of the lithium salt include lower lithium carboxylate, lithium halide, lithium nitrate, lithium perchlorate, lithium hexafluorophosphate, lithium borofluoride, lithium chloroboranate, fluorine-containing alkylsulfonylimide lithium, lithium hexafluoroarsenate, lithium hexafluoroantimonate, lithium 4-phenylborate, lithium bisoxalatoborate, and LiCₙF₂ₙ₊₁SO₃ (n represents an integer of 1 or more). The lithium salt may contain one of these alone or two or more thereof. Among them, lithium salt is preferably lithium perchlorate because the lithium perchlorate improves the conductivity of the electrolytic solution 70 and the long-term reliability of the battery 1 and is inexpensive.

Lithium salts can be identified using a mass spectrometer. In a glove box under an argon atmosphere, the battery 1 is disassembled using a nipper. The electrolytic solution 70 is extracted with an extraction solvent (for example, dehydrated acetonitrile). Anions contained in the obtained extraction solution are ionized and introduced into a quadrupole-time-of-flight mass spectrometer (“Xevo (registered trademark) G2-SQTof MS” manufactured by Waters Corporation) to perform analysis.

The content of the lithium salt is preferably 12% by mass or less, more preferably 0.5% by mass to 12% by mass, and still more preferably 1% by mass to 12% by mass with respect to 100% by mass of the electrolytic solution. When the content of the lithium salt is 12% by mass or less, an increase in electrical resistance of the positive electrode 30 is further suppressed while electrical characteristics such as a battery capacity are secured.

The content of the lithium salt can be determined using a high frequency inductively coupled emission spectrometer (“SPS-3520” manufactured by SII NanoTechnology Inc.). However, when the lithium salt is composed of fluorine atoms, the content of the lithium salt can be determined using a fluorine 19 nuclear magnetic resonance apparatus (“JNM-ECA400 W” manufactured by JEOL Ltd., internal standard: hexafluorobenzene (C₆F₆: 163 ppm)).

The non-aqueous solvent is an aprotic organic solvent. The non-aqueous solvent preferably contains, for example, a cyclic carbonate ester or a cyclic carbonate ester and an ether compound from the viewpoint of being chemically stable under a high temperature environment (under the 260° C. environment). Here, the expression “chemically stable under a high-temperature environment” means that the vapor pressure is not too large under a high temperature environment and that the solvent hardly causes a decomposition reaction, and as a result, when the solvent is contained in the electrolytic solution 70 of the battery 1, the battery 1 exhibits a property of being hardly deformed under the high temperature environment. Examples of the cyclic carbonate ester include alkylene carbonate (more specifically, ethylene carbonate, propylene carbonate, and butylene carbonate, and cyclic carbonate ester having an unsaturated bond (carbon-carbon double bond) (more specifically, vinylene carbonate and the like). Examples of the ether compound include a chain ether compound and a cyclic ether compound. Examples of the chain ether compound include a symmetric chain ether compound (for example, glycol ether compounds represented by RO(C₂H₅O)ₙR (2 Rs each represent the same alkyl group having 1 to 3 carbon atoms, and n represents an integer of 1 to 5) such as 1,2-dimethoxyethane (monoglyme), diglyme, triglyme, tetraglyme and pentaglyme) and an asymmetric chain ester compound (more specifically, methoxyethoxyethane or the like). Examples of the cyclic ether compounds include tetrahydrofuran and 1,3-dioxolane.

In a preferred aspect, the non-aqueous solvent contains alkylene carbonate, and preferably contains a solvent of at least one of propylene carbonate and butylene carbonate, from the viewpoint of further improving the heat resistance of the battery 1. Furthermore, in a preferred aspect, from the viewpoint of further improving the heat resistance of the battery 1, the non-aqueous solvent preferably contains a cyclic carbonate ester and a glyme having a boiling point of 150° C. or higher, more preferably contains at least one of propylene carbonate and butylene carbonate, and contains at least one solvent selected from the group consisting of diglyme, triglyme, and tetraglyme. When the non-aqueous solvent contains at least one of diglyme, triglyme, and tetraglyme, these glyme have a moderate molecular weight. Thus, the vapor pressure under a high temperature environment does not become too large, and deformation of the battery 1 is suppressed. Since the viscosity of the electrolytic solution 70 is not excessively increased, mobility of Li ions in the electrolytic solution 70 is not suppressed.

The non-aqueous solvent can be specified as follows. In a glove box under an argon atmosphere, the battery 1 is disassembled using a nipper. The electrolytic solution 70 is extracted with an extraction solvent (for example, dehydrated acetonitrile). The obtained extraction solution is used as an analytical sample. The analytical sample is analyzed using a gas chromatograph mass spectrometer (“6890 Series Gas Chromatograph” and “5975 Series Mass Selective Detector” manufactured by Agilent).

The electrolytic solution 70 may contain an alkali metal compound. The alkali metal compound suppresses the progress of the decomposition reaction of the electrolytic solution (in particular, under a high temperature environment of less than 260° C.). Thus, an alkali metal compound can be added to the electrolytic solution 70 according to a degree of heat resistance required in the use environment of the battery 1. The alkali metal compound is represented by, for example, the general formula (2):

[Chem. 2]

MeN(CₓF₂ₓ₊₁SO₂) ( C_{y}F_{2y÷1}SO₂) . . . (2)

[in the general formula (2), Me represents an alkali metal element, and x and y each independently represent an integer of 0 or more].

### [Method of Manufacturing Flat-Type Non-Aqueous Electrolytic Solution Battery]

An example of a method of producing a flat-type non-aqueous electrolytic solution according to the first embodiment will be described. The method of manufacturing the battery 1 includes, for example, a reduction treatment step, a positive electrode mixture preparation step, an electrolytic solution preparation step, a positive electrode conductive layer forming step, a housing step, and an engagement step.

### (Reduction Treatment Step)

In the reduction treatment step, manganese dioxide as the positive electrode active material is reduced. The reduction treatment of manganese dioxide can be performed by, for example, an immersion method and a spray drying method. In the immersion method, manganese dioxide as a positive electrode active material is immersed in a reducing agent to reduce a part of manganese dioxide. In the spray drying method, a part of manganese dioxide as the positive electrode active material is reduced by hot air. The reduction of manganese dioxide may be performed by either the spray drying method or the immersion method. The spray drying method is preferable as an industrial reduction treatment method from the viewpoint of uniformly applying heat to a raw material (manganese dioxide) to uniformly reduce MnO₂.

In the immersion method, manganese dioxide is dispersed in a reducing agent solution. Examples of the reducing agent include an anhydrous dicarboxylic acid compound. The dicarboxylic anhydride compound has the same meaning as the dicarboxylic anhydride compound as a component of the electrolytic solution 70. A degree of reduction of manganese dioxide can be adjusted by the particle size of manganese dioxide, the type of the reducing agent, the concentration of the reducing agent in the reducing agent solution, the temperature at the start of the reduction reaction, and the immersion time.

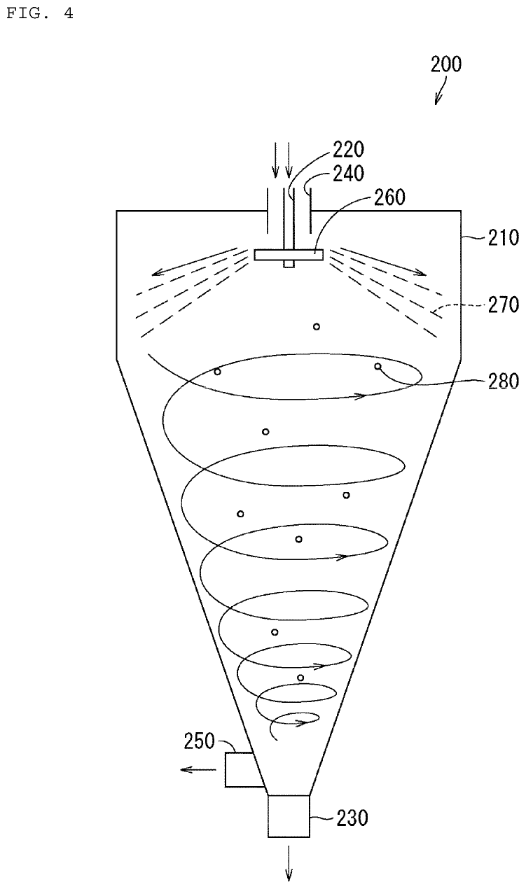

The reduction treatment of manganese dioxide by the spray drying method will be described with reference to FIG. 4. FIG. 4 is a schematic view showing a spray dryer (spray drying apparatus) for producing the positive electrode mixture 31 contained in the battery 1. The spray dryer 200 includes a main body 210, a raw material supply port 220, a collection port 230, a hot air supply port 240, a hot air discharge port 250, and a disk 260.

In the reduction treatment of manganese dioxide, first, manganese dioxide and a positive electrode binder are dispersed in a solvent to prepare a MnO₂ dispersion. The solvent contained in the dispersion is not particularly limited as long as manganese dioxide can be dispersed and reduced. Examples of such a solvent include cyclic carbonate ester compounds (more specifically, ethylene carbonate (EC), butylene carbonate (BC), fluoroethylene carbonate (FEC), and the like), cyclic amide compounds and N-alkyl-substituted derivatives (more specifically, 2-pyrrolidone, N-methylpyrrolidone (NMP), and the like), and chain carbonate ester compounds (more specifically, dimethyl carbonate (DMC), ethyl methyl carbonate (EMC), and diethyl carbonate (DEC)). Among them, the solvent is preferably NMP.

The positive electrode binder is preferably one that is sufficiently dispersed in the MnO₂ dispersion, and is preferably, for example, polyvinylidene fluoride. When the positive electrode binder is sufficiently dispersed in the MnO₂ dispersion, the reduction reaction of MnO₂ is hardly inhibited. A weight average molecular weight Mw of polyvinylidene fluoride is preferably 3.0×10⁵ to 7.0×10⁵ or less. When the weight average molecular weight Mw of polyvinylidene fluoride is 3.0×10⁵ to 7.0×10⁵ g/mol, the components contained in the positive electrode mixture 31 are suitably fixed (bound) to maintain the shape of the positive electrode mixture 31, and the reduction reaction of manganese dioxide is hardly inhibited.

The MnO₂ dispersion is charged into the main body 210 from the raw material supply port 220. The charged MnO₂ dispersion reaches the disk 260 via the raw material supply port 220. The disk 260 rotates along an axis on which the material supply port 220 extends. The disk 260 has a plurality of holes. Thus, the MnO₂ dispersion that has reached the disk 260 is sprayed as droplets 270 into the main body 210 by centrifugal force due to the rotation of the disk 260.

The hot air is supplied into the main body 210 through the hot air supply port 240, and is discharged from the main body 210 through the hot air discharge port 250. The hot air is brought into contact with the droplets 270 of the MnO₂ dispersion charged into the main body 210 in a swirling manner in the main body 210. The droplets 270 come into contact with hot air to remove the solvent and reduce a part of MnO₂, thereby preparing MnO₂ particles 280. The prepared MnO₂ particles 280 are collected from the inside of the main body 210 through the collection port 230. A part of the surface of the prepared MnO₂ particles 280 is reduced.

In the reduction treatment step, the degree of reduction of manganese dioxide can be adjusted by conditions such as the temperature in the main body 210 (for example, 100° C. to 220° C.), the rotation speed, and the speed of hot air. The temperature within the main body 210 may form a temperature gradient that varies (increases or decreases) from the raw material supply port 220 toward the collection port 230 of the main body 210.

In the positive electrode mixture preparation step, the positive electrode mixture 31 is prepared. Specifically, the positive electrode active material subjected to a reduction treatment, the positive electrode binder, the positive electrode conductive agent, and the solvent are mixed to prepare a positive electrode mixture dispersion liquid. The solvent is not particularly limited as long as the components of the positive electrode mixture 31 can be mixed and evaporated. Examples of the solvent contained in the positive electrode mixture dispersion liquid include a protic solvent such as water and an aprotic solvent.

When the protic solvent (more specifically, water or the like) is used as the solvent contained in the positive electrode mixture dispersion liquid, the positive electrode binder is preferably PTFE from the viewpoint of improving dispersibility. When the aprotic solvent is used as the solvent contained in the positive electrode mixture dispersion liquid, the positive electrode mixture is preferably polyvinylidene fluoride from the viewpoint of improving the dispersibility.

Subsequently, the solvent is removed from the positive electrode mixture dispersion liquid to obtain a powder. Thereafter, the resulting powder is pressure-molded using a tablet pressing machine to prepare a flat pellets (molded body). In this way, the positive electrode mixture 31 is prepared.

### (Electrolytic Solution Preparation Step)

A lithium salt, a non-aqueous solvent, and an anhydrous dicarboxylic acid compound are mixed to prepare the electrolytic solution 70.

### (Positive Electrode Conductive Layer Forming Step)

A paste (for example, a silver paste containing silver, an alloy paste containing a lithium aluminum alloy, a carbon paste containing a carbon material, and the like) containing a conductive material is applied to an inner bottom surface of the positive electrode container 11, and the coating film is dried to form the positive electrode conductive layer 60.

In the housing step, the positive electrode mixture 31 is housed in the positive electrode container 11, and the negative electrode 40 is housed in the negative electrode container 12. Specifically, the positive electrode mixture 31 is disposed and housed on the positive electrode conductive layer 60 of the positive electrode container 11, and the positive electrode mixture 31 is indirectly connected to the positive electrode container 11 with the positive electrode conductive layer 60 interposed therebetween. On the other hand, the negative electrode 40 (for example, a lithium metal foil which is a lithium simple substance) is housed in the negative electrode container 12.

In the engagement step, first, the negative electrode 40 is housed in the negative electrode container 12, the separator 50 and the gasket 20 are stacked on the negative electrode 40, and these are impregnated with the electrolytic solution 70. The positive electrode mixture 31 and the positive electrode conductive layer 60 are housed in a positive electrode container 11. Next, the positive electrode container 11 is stacked on the negative electrode container 12 such that the opening portions of the positive electrode container 11 and the negative electrode container 12 face each other. Peripheral edge portions of the negative electrode container 12 and the positive electrode container 11 are crimped with the gasket 20 interposed therebetween, and the negative electrode container 12 and the positive electrode container 11 are engaged with each other. As a result, the battery 1 in which the positive electrode 30, the negative electrode 40, and the like are sealed in a state of being housed in the battery can 10 is produced. A surface of the separator 50 may be coated with a surfactant or the like.

In an embodiment, a negative electrode conductive layer 80 and a positive electrode ring 90 are provided and the positive electrode conductive layer 60 is not provided. This different configuration will be described below, where the same reference numerals denote the same configurations as those described above, and thus the description thereof will be omitted in principle.

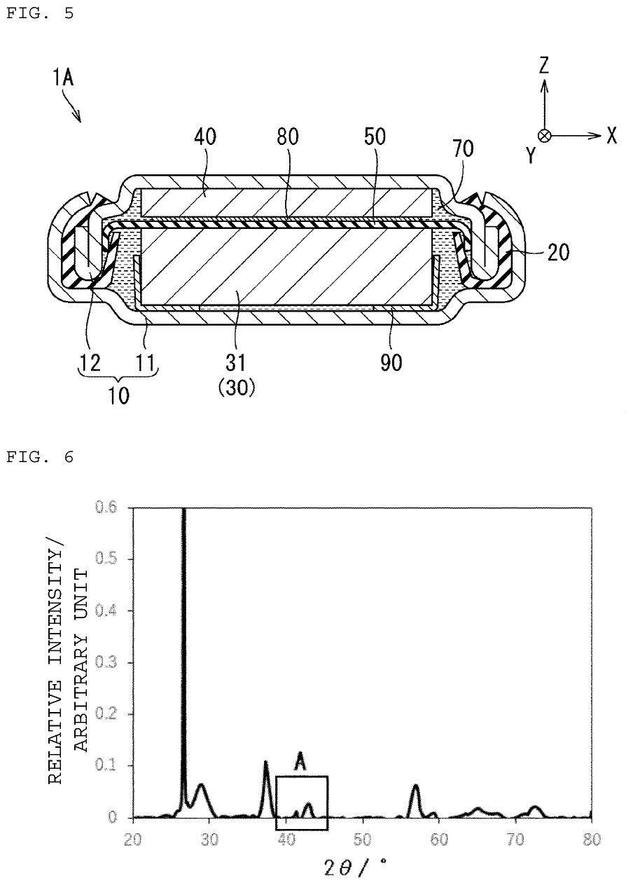

A battery 1A according to an embodiment will be described with reference to FIG. 5. FIG. 5 is a sectional view showing the battery 1A.

As shown in FIG. 5, the battery 1A further includes the negative electrode conductive layer 80 between a negative electrode 40 and a separator 50. A negative electrode container 12 is indirectly connected to the negative electrode 40 with the negative electrode conductive layer 80 interposed therebetween.

The negative electrode conductive layer 80 is interposed between the negative electrode container 12 and the negative electrode 40. When the battery 1A includes the negative electrode conductive layer 80, the internal resistance of the battery 1A decreases, and discharge performance under various conditions in the (primary) battery 1A is improved. The negative electrode conductive layer 80 contains a powdery conductive material (a plurality of conductive particles and conductive powder). The conductive material includes at least one of silver, a lithium aluminum alloy, and a carbon material. The negative electrode conductive layer 80 may be composed of one of these conductive materials alone, or may be composed of two or more of these conductive materials.

The battery 1A further includes the positive electrode ring 90 having an L shape in a ZX sectional view. The battery 1A has a so-called L shape. Specifically, the battery 1A has a ring shape in an XY plane view, and a portion parallel to an X direction of the L shape (in the ZX sectional view) is located on an inner peripheral side in the XY plane view with respect to a portion parallel to a Z direction of the L shape. The positive electrode ring 90 covers a part of a side surface and a part of a bottom surface of a positive electrode mixture 31. A part of the positive electrode ring 90 is joined to the inner bottom surface of the positive electrode container 11 (for example, by welding). When the battery 1A includes the positive electrode ring 90, an increase in internal resistance of the battery 1 can be suppressed, and discharge stability of the battery 1A is improved.

A method of manufacturing the battery 1A further includes a negative electrode conductive layer forming step and a positive electrode ring disposing step, and does not include the positive electrode conductive layer forming step, as compared with the method of manufacturing the battery 1.

In the negative electrode conductive layer forming step, a paste (for example, a silver paste containing silver, an alloy paste containing a lithium aluminum alloy, a carbon paste containing a carbon material, and the like) containing a conductive material is applied onto the separator 50, and the coating film is dried to form the negative electrode conductive layer 80.

In the positive electrode mixture preparation step, the positive electrode ring 90 and the positive electrode mixture 31 are integrally molded so that the positive electrode ring 90 covers a part of the bottom surface and a part of the side surface of the positive electrode mixture 31.

In the housing step, the positive electrode mixture 31 integrally molded with the positive electrode ring 90 is housed in the positive electrode container 11 such that a lower surface of the positive electrode ring 90 is in contact with the inner bottom surface of the positive electrode container 11. When the positive electrode mixture 31 is housed in the positive electrode container 11, the positive electrode ring 90 and the inner bottom surface of the positive electrode container 11 may be joined by welding.

The present disclosure is not limited to the above-described embodiments, and is thus modifiable including as described below according to an embodiment.

In an embodiment, the reduction treatment of a part of the positive electrode mixture 31 is performed by the spray drying method in the method of manufacturing the battery 1; however, the present technology is not limited thereto. The positive electrode mixture dispersion liquid may be subjected to a reduction treatment by heating and drying using an oven. The conditions for heating and drying are, for example, a temperature of 160° C. to 230° C. under reduced pressure and a heating time of 20 to 30 hours.

In an embodiment, the positive electrode mixture dispersion liquid is charged into the main body 210 of the spray dryer 200 by a disk method (rotary admizer method); however, the present technology is not limited thereto. For example, a spray nozzle method can be adopted instead of the disk method in which the positive electrode mixture dispersion liquid is sprayed and charged into the main body 210 of the spray dryer 200 by the disk 260. In the spray nozzle method, instead of the disk 260, the positive electrode mixture dispersion liquid is sprayed and charged into the main body 210 by a nozzle.

In an embodiment, the positive electrode ring 90 covers a part of the bottom surface and a part of the side surface of the positive electrode mixture 31; however, the present technology is not limited thereto. For example, the positive electrode ring may cover only a part of the side surface of the positive electrode mixture. In this case, the battery is a so-called hat type. For example, the battery has a ring shape in the XY plane view, and a portion parallel to the X direction of the L shape (in the ZX sectional view) is located on the outer peripheral side in the XY plane view with respect to a portion parallel to the Z direction of the L shape.

### EXAMPLES

Hereinafter, the present disclosure will be described in further detail including with reference to Examples according to an embodiment. Parts are parts by mass.

### Example 1-1

### [1. Manufacture of Primary Battery]

### (1-1. Raw Materials)

The following raw materials were used.

### —Positive Electrode—

[Positive electrode active material]
Manganese dioxide (“electrolytic manganese dioxide” manufactured by CHORI CO., LTD.)

[Solvent for MnO₂ dispersion liquid]
Water (pure water)
N-methylpyrrolidone (NMP) (manufactured by Mitsubishi Chemical Corporation)

[Positive electrode binder]
Polytetrafluoroethylene (PTFE) (“Lubron L-2” manufactured by DAIKIN INDUSTRIES, LTD.)

[Positive electrode conductive agent]
Graphite as carbon material (“ACB-150” manufactured by Nippon Kokuen Inc.)
Ketjen black (“carbon ECP” manufactured by Lion Specialty Chemicals Co., Ltd.)

### —Negative Electrode—

Lithium-based material (lithium simple substance) lithium metal foil (manufactured by Honjo Metal Co., Ltd.), lithium metal (purity: 99.99%) obtained by subjecting a thickness of 1.0 mm to pressure processing and molding the resultant into 0.88 mm

### —Battery Can—

[Positive electrode container and negative electrode container]
Stainless steel (“manufactured by Hitachi Metals, Ltd.”, using a positive electrode container prepared by press-molding nickel-plated SUS 430, and a negative electrode container)

### —Electrolytic Solution—

Electrolytic solution (manufactured by Tomiyama Pure Chemical Industries, Ltd.): A solvent, lithium perchlorate (LiClO₄) (lithium salt), and pyromellitic anhydride (anhydrous dicarboxylic acid: concentration 0 wt %, 1 wt %, 3 wt % or 5 wt %) are contained.

The solvent is one or two solvents selected from the group consisting of ethylene carbonate, propylene carbonate, butylene carbonate, 1,2-dimethoxyethane, diglyme, triglyme, and tetraglyme.

### —Separator—

Nonwoven fabric (manufactured by TAPYRUS CO., LTD., thickness: 320 μm, weight: 70 g/m², polyphenylene sulfide material nonwoven fabric)

### —Positive Electrode Conductive Layer—

Carbon paste (manufactured by Nippon Kokuen Inc., Varniphite IV174-D01)

### (1-2. Production of Positive Electrode)

Manganese dioxide (γ-MnO₂) was calcined at a temperature of 440° C. for 3 hours to form manganese dioxide (β-MnO₂) (degree of β-conversion: 90%). 92 parts of manganese dioxide (β-MnO₂) as the positive electrode active material, 1 part of polytetrafluoroethylene (PTFE) as the positive electrode binder, 6 parts of natural graphite as the positive electrode conductive agent, and 1 part of Ketjen black were mixed to obtain 100 parts of a positive electrode mixture (mixture). 100 parts of the positive electrode mixture (mixture) was charged into pure water as an aqueous solvent so as to have a solid content ratio (mass ratio of components other than the solvent in the positive electrode mixture) of 65% by mass, and the mixture was stirred for 30 minutes using a stirrer (“Planetary Dispa” manufactured by Asada Iron Works Co., Ltd.). Thus, a positive electrode mixture dispersion liquid was prepared. Subsequently, a container containing a positive electrode dispersion liquid was placed in an oven, and the positive electrode mixture dispersion liquid was heated and dried under the conditions of a heating temperature of 170° C. (the value in the drying temperature column in Table 1) and a reduced pressure for 24 hours. As a result, a positive electrode mixture (dry powder) in which a part of the positive electrode active material was subjected to the reduction treatment was obtained. Using a tablet pressing machine equipped with a die punch (diameter Φ 14.00 mm), 0.86 parts of the positive electrode mixture (dry powder) was weighed, and pressure-molded at 100 kN. In this way, the pellet-like coin type positive electrode mixture 31 (positive electrode 30: outer diameter 14.0 mm, thickness 1.82 mm, volume density 2.90 g/cm³) was prepared. The positive electrode mixture 31 contains manganese dioxide (β-MnO₂) as a positive electrode active material, PTFE as a positive electrode binder, and natural graphite and Ketjen black as a positive electrode conductive agent.

### (1-3. Formation of Positive Electrode Conductive Layer)

The carbon paste was applied to the inner bottom surface of the positive electrode container 11, and the coating film was dried. As a result, the positive electrode conductive layer 60 containing a carbon material was formed on the inner bottom surface of the positive electrode container 11.

### (1-4. Production of Negative Electrode)

A lithium metal foil (outer diameter: 16.5 mm and thickness: 0.88 mm) was press-molded and attached to the surface of nickel-plated SUS 430. As a result, the negative electrode container 12 in which the negative electrode 40 was disposed on the inner bottom surface was produced.

### 1-5. Provision of Non-Aqueous Electrolytic Solution

A non-aqueous electrolytic solution (manufactured by Tomiyama Pure Chemical Industries, Ltd.: Example 1-1 in Table 1) containing 6% by mass of lithium perchlorate (LiClO₄) as a lithium salt, 5% by mass of pymellitic anhydride (PMDA) as a dicarboxylic anhydride, and a cyclic carbonate ester (propylene carbonate (PC)) as a solvent was provided.

### (1-6. Assembly of Primary Battery)

First, the separator 50 (nonwoven fabric made of polyphenylene sulfide having a thickness of 320 μm and a weight of 70 g/m²) was disposed on the negative electrode 40 disposed on the inner bottom surface of the negative electrode container 12. Thereafter, the gasket 20 (polyphenylene sulfide having a thickness of 0.37 mm) was disposed on the separator 50.

Subsequently, the electrolytic solution 70 was dropped into the negative electrode container 12 from above the gasket 20. Thereafter, the positive electrode 30 was disposed on the gasket 20. As a result, each of the positive electrode 30, the negative electrode 40, and the separator 50 was impregnated with a part of the electrolytic solution.

Finally, the positive electrode container 11 was disposed on the positive electrode 30, and then the positive electrode container 11 and the negative electrode container 12 were pressure-bonded and fixed to each other using a crimper. As a result, the battery can 10 was formed, and the positive electrode 30, the negative electrode 40, the separator 50, and the like were sealed in the battery can 10, so that a primary battery (outer diameter: 20 mm and thickness: 3.2 mm) was prepared.

### 2. Measurement Method

(2-1. Method of Determining Peak Intensity Ratio I₂/I₁)

The XPS spectrum of the positive electrode mixture 31 was measured using a scanning X-ray photoelectron spectrometer (“Quantera-SXM” manufactured by ULVAC-PHI, INCORPORATED.). The positive electrode mixture 31 as a measurement sample was provided as follows: the battery 1 was disassembled in a glove box under an argon atmosphere, and the positive electrode mixture taken out was washed twice with dimethoxyethane (DME). After washing, DME in a washing liquid was dried and removed.

The measurement conditions were as follows;
X-ray source: Al-Kα radiation (1486.6 eV mono at 25 W)
Beam diameter: Φ100 μm
Neutralization gun: 1.0 V 20.0 μA
Analyser Mode: FAI.

From the obtained XPS spectrum, the peak intensity I₁ at a binding energy of 642 eV and the peak intensity I₂ at a binding energy of 640 eV were measured. Here, the peak intensity is a maximum peak intensity (not the integrated value of the peaks). The peak intensity ratio I₂/I₁ was calculated from the obtained I₁ and I₂.

### (2-2. Method of Confirming Diffraction Peak in X-Ray Diffraction Spectrum)

The X-ray diffraction spectrum of the positive electrode mixture 31 was measured using an X-ray diffractometer (“Ultima-IV” manufactured by Rigaku Corporation).

The positive electrode mixture 31 as a measurement sample was provided as follows: the battery 1 was disassembled, and the positive electrode mixture taken out was washed with dimethoxyethane (DME). Thereafter, the positive electrode mixture was washed with pure water. After washing, pure water was removed by drying. The washed positive electrode mixture was ground in a mortar to prepare a powder sample as a measurement sample.

The measurement conditions were as follows.
X-ray source: Cu-Kα ray
Attachment: ASC10_Refelection
Detector: D/teX Ultra 250 (H)
Goniometer: Standard goniometer
Primary beam: Standard
X-ray generator output: 45 kV
X-ray generator current: 200 mA
Scan speed: 5°/min
Step width: 0.01⁰
Scan axis: 2θ/θ
Scan range: 1° to 80°

From the obtained X-ray diffraction spectrum, the presence or absence of the diffraction peak located on the low angle side at a diffraction angle 20=41.3°+0.1⁰ was confirmed.

### (2-3. Method of Measuring Specific Surface Area of Positive Electrode Mixture)

The positive electrode mixture was pulverized in a mortar to obtain a mixed powder containing MnO₂, the positive electrode conductive agent, and the positive electrode binder. The obtained mixed powder was used as a measurement sample. An adsorption isotherm was measured under the conditions of a temperature of 77° C. and a nitrogen atmosphere using a specific surface area/pore distribution measuring device (“BELSORP-MINI” manufactured by MicrotracBEL Corp.). The obtained adsorption isotherm was analyzed to obtain a specific surface area (m²/g).

(2-4. Method of Determining W₂/W₁)

First, a mass W_{A} of the battery was measured.

Next, the battery was disassembled to collect constituent members (positive electrode mixture, negative electrode, separator, battery can (positive electrode container and negative electrode container), gasket, and positive electrode conductive layer) of the battery. The electrolytic solution adhered to each constituent member was washed away using a washing organic solvent (for example, dimethyl carbonate). A washing solution containing the electrolytic solution was filtered, and the positive electrode conductive layer was separated by filtration. Thereafter, each constituent member was dried.

The mass of each constituent member was measured. Thereby, the mass W₂ of the positive electrode mixture was obtained. In addition, a sum W_{B} of the masses of the constituent members other than the electrolytic solution was calculated. From the obtained W_{A} and W_{B}, the mass W₁ (=W_{A}— W_{B}) of the electrolytic solution was obtained. From the obtained W₁ and W₂, the mass ratio W₂/W₁ of the electrolytic solution to the positive electrode mixture was calculated using the formula (2).

### 3. Evaluation Methods

(3-1. Method of Evaluating Swelling Characteristic of Battery after Heat Treatment (260° C., 5 Minutes))

A thickness T₁ (in the Z direction) of a central portion of the battery 1 under a normal temperature environment (temperature: 23° C.) was measured. Here, the central portion, which was a measurement point of the thickness of the battery 1, was a center point of a substantially circular shape in the XY plane view. Next, the battery 1 was allowed to stand under a high temperature environment (temperature: 260° C.) for 5 minutes, then returned to a normal temperature environment, and naturally cooled. Next, the battery 1 was discharged at a current of 10 mA for 0.5 seconds. Thereafter, the thickness T₂ (in the Z direction) of the central portion of the battery 1 after the heat treatment was measured.

The swelling amount (mm) was calculated from the thicknesses T₁ and T₂ of the obtained battery by the formula (4):

[Math. 4]

Swelling amount·(mm)=T₂−T₁ . . . (4)

[in the formula (4), T₁ represents the thickness of the battery 1 not subjected to the heat treatment (temperature 260° C. and 5 minutes), and T₂ represents the thickness of the battery 1 subjected to the heat treatment]. The evaluation results are summarized in Table 1.
(3-2. Method of Evaluating Swelling Characteristic of Battery after Heat Treatment (150° C., 100 h))

The swelling amount (mm) was calculated similarly to 3-1., except that the heat treatment was changed from “temperature 260° C. and 5 minutes” to “temperature 100° C. and 100 hours”. This evaluation was performed in Examples of Table 2.

### (3-3. Open Circuit Voltage (OCV) Failure Rate)

Open circuit voltage characteristics of the battery 1 were evaluated for OCV based on a method of measuring OCV described later, and an OCV failure rate was measured. As a defect determination criterion, the battery before discharge was determined to be defective when the value of OCV was 3.05 V or less. As a method of calculating the failure rate, the failure rate was calculated by analyzing N+1000×100 (unit: %) where N is the number of occurrences with respect to a total number of produced batteries of 1000.

### (3-4. Measurement of Open Circuit Voltage)

The open circuit voltage of the battery 1 was measured. Specifically, a voltage value when a resistor of 1 MΩ was connected under an environment of 23° C. was used as an OCV measurement condition. This measurement was performed in Examples of Tables 2 and 7.

### (3-5. Measurement of Electrical Resistance)

The electrical resistance of the battery 1 was measured. Specifically, an AC voltage V and an AC current I were measured by generating an AC wave having an amplitude of 10 mV and a frequency of 1 kHz with the OCV as a reference, and the electrical resistance was calculated by measuring an impedance value measured by V/I. As a device for measuring impedance, Squidstat Plus manufactured by Admiral was used.

### (3-5. Measurement of Discharge Capacity)

The discharge capacity of the battery 1 was measured. Specifically, constant resistance discharge of 15 kΩ was performed under an environment of 23° C., and a direct current generated at that time was measured by an ammeter. The capacity was calculated by integrating direct current (mA)× discharge time (h) at each time. As the discharge time, a time from the start of discharge to a moment when a closed circuit voltage reached 2 V or less was defined as the discharge time. This measurement was performed in Example of Table 4.

### (3-6. Measurement of Liquid Absorption Amount of Pellet)

The liquid absorption amount of the pellet (positive electrode mixture) of the battery 1 was measured. Specifically, (WA-WB) mg measured in the following manner was taken as the liquid absorption amount of the pellet. First, after pellet formation, vacuum drying was performed at 300° C. for 2 hours. Next, the weight of the pellet after 10 hours after drying was weighed as WB (mg) with an electronic balance. In addition, the pellet was immersed in the electrolytic solution (obtained by dissolving LiClO₄ by 4.8% at a weight ratio of PC: DME=1:2) for 6 minutes, and the weight of the pellet after 6 minutes was measured as WA (mg). A difference (WA−WB) (mg) between WA and WB measured in this manner was defined as the liquid absorption amount of the pellet. This measurement was performed in Example of Table 4.

(3-7. Measurement of Discharge Capacity after Heat Treatment (260° C., 5 Minutes))

The discharge capacity of the battery 1 after heat treatment (260° C., 5 minutes) was measured. Specifically, after the heat treatment (260° C., 5 minutes), the battery was left standing under an environment at 23° C. for 24 hours to be naturally cooled. Thereafter, constant resistance discharge of 15 kΩ was performed under an environment of 23° C., and direct current (mA)×discharge time (h) was measured to calculate the capacity. As the discharge time, the time from the start of discharge to the moment when the voltage reached 2 V or less was defined as the discharge time. This measurement was performed in Example of Table 6.

### (3-8. Discharge Evaluation According to IEC Standard)

The battery 1 was evaluated for discharge according to the IEC standard. Specifically, the constant resistance discharge of 15 kΩ was performed under an environment of 23° C., and direct current (mA)×discharge time (h) was measured to calculate the capacity. As the discharge time, the time from the start of discharge to the moment when the voltage reached 2 V or less was defined as the discharge time. In the IEC standard, it is required to secure 180 mAh or more in a coin battery of CR2032 size under this condition. This measurement was performed in Example of Table 6.

### (3-9. Leakage Evaluation)

Leakage evaluation of the battery 1 was performed. Specifically, the battery 1 was subjected to the heat treatment (260° C., 5 minutes), and then naturally cooled (was left standing at normal temperature for 30 minutes) under an environment of 23° C. for 24 hours. The appearance of the battery 1 after being left standing at normal temperature was observed with a microscope, and the presence or absence of the electrolytic solution leaking onto the gasket was determined. If necessary, the battery mass was further measured, and then the battery was left standing at normal temperature for 1 day. Thereafter, the battery mass was measured, and a difference between the battery mass before and after being left standing at normal temperature for 1 day (=the battery mass before being left standing at normal temperature for 1 day −the battery mass after being left standing at normal temperature for 1 day) was calculated. From the obtained observation results, the leakage evaluation was performed based on the following evaluation criteria. This measurement was performed in Example of Table 6.

### (Evaluation Criteria for Leakage)

∘ (good): generation of the electrolytic solution leaking onto the gasket cannot be confirmed, and a decrease in battery mass of less than 1 mg can be observed after the battery is left standing at normal temperature for 1 day.
× (bad): generation of the electrolyte solution leaking onto the gasket can be confirmed, or if the generation cannot be confirmed, a decrease in battery mass of 1 mg or more can be observed after the battery is left standing at normal temperature for 1 day.

### (3-10. Method of Measuring Pellet Crack Occurrence Rate)

The occurrence of pellet cracking of the battery 1 was investigated. Specifically, the entire surface of the pellet (pellet-shaped coin-type positive electrode mixture) was observed with a microscope, and the pellet cracking was determined by inspecting whether or not occurrence of cracking was observed by visual appearance inspection. When cracking was observed in part, the number of cracks was counted, and the number of cracks generated per 100 pellets was measured to calculate a pellet crack occurrence rate. This measurement was performed in Example of Table 8.

### Examples 1-2 to 1-3 and Comparative Examples 1-1, 1-3 to 1-4, and 1-6: Reduction Treatment of Positive Electrode Mixture by Immersion Method

In Examples 1-2 to 1-3 and Comparative Examples 1-1, 1-3 to 1-4, and 1-6, the battery 1 was produced similarly to Example 1-1 except that at least one of the type of the solvent of the positive electrode mixture dispersion liquid, the drying temperature of the positive electrode mixture dispersion liquid, the type of the positive electrode binder, and the content of dicarboxylic anhydride in the electrolytic solution was changed as shown in Table 1.

For the batteries 1 of Examples 1-2 to 1-3 and Comparative Examples 1-1, 1-3 to 1-4, and 1-6, the determination of the intensity ratio I₂/I₁ of the positive electrode mixture 31 and the confirmation of the XRD peak shift were performed similarly to Example 1-1. In addition, evaluation (measurement of the swelling amount and calculation of the OCV failure rate) was performed similarly to Example 1-1. The measurement results and the evaluation results are summarized in Table 1.

### Example 1-4

In Example 1-4, the battery 1 was produced similarly to Example 1-1 except that the method of reducing the positive electrode active material was changed, and at least one of the type of the solvent of the dispersion liquid, the drying temperature, the type of the positive electrode binder, and the content of dicarboxylic anhydride in the electrolytic solution was changed as shown in Table 1.

In Example 1-4, the spray drying method was used instead of heating in an oven for the reduction treatment of the positive electrode active material. Specifically, the prepared positive electrode mixture dispersion liquid was charged into a spray dryer (“MOC-16” manufactured by Ohkawara Kakohki Co., Ltd.), and the reduction treatment was performed under the following conditions.
A temperature gradient was set in the main body 210. Specifically, the temperature (input temperature) of the hot air supplied to the main body 210 was set to 205° C., and the temperature (output temperature) of the hot air discharged from the main body 210 was set to 105° C. (temperature lower by 100° C. than the input temperature). The numerical value in the drying temperature column in Table 1 indicates the input temperature.
The number of revolutions of the disk was 15,000 rpm.
The treatment amount of the positive electrode mixture dispersion liquid was 14.0 kg/hour. Since the positive electrode mixture dispersion liquid had a high viscosity, a Mohno pump was used to supply the positive electrode mixture dispersion liquid into the main body 210.

The intensity ratio I₂/I₁ of the positive electrode mixture 31 was determined and the XRD peak shift was confirmed similarly to Example 1-1. In addition, evaluation (measurement of the swelling amount and calculation of the OCV failure rate) was performed similarly to Example 1-1. The measurement results and the evaluation results are summarized in Table 1.

### Examples 1-5 to 1-6 and Comparative Examples 1-2, 1-5, and 1-7 to 1-8: Reduction Treatment of Positive Electrode Mixture by Spray Drying Method

In Examples 1-5 to 1-6 and Comparative Examples 1-2, 1-5, and 1-7 to 1-8, the battery 1 was produced similarly to Example 1-4 except that at least one of the type of the solvent of the positive electrode mixture dispersion liquid, the drying temperature of the positive electrode mixture dispersion liquid, the type of the positive electrode binder, and the content of dicarboxylic anhydride in the electrolytic solution was changed as shown in Table 1.

For the batteries 1 of Examples 1-5 to 1-6 and Comparative Examples 1-2, 1-5, and 1-7 to 1-8, the determination of the intensity ratio I₂/I₁ of the positive electrode mixture 31 and the confirmation of the XRD peak shift were performed similarly to Example 1-1. In addition, evaluation (measurement of the swelling amount and calculation of the OCV failure rate) was performed similarly to Example 1-1. The measurement results and the evaluation results are summarized in Table 1.

TABLE 1

| | | | | | | | | Evaluation | |
|---|---|---|---|---|---|---|---|---|---|
| | | | | | | | Electrolytic | Swelling | |
| | Positive electrode mixture | | | | | | solution | amount | OCV |
| | | | Drying | Positive | | XRD | Dicarboxylic | [260° C., | failure |
| | Spray | Treatment | temperature | electrode | | peak | anhydride | 5 | rate |
| | dry | solvent | (° C.) | binder | I₂/I₁ | shift | (wt %) | minutes] | (%) |
| Comparative | X | H₂O | 170 | PTFE | 0.20 | Absence | 0 | Rupture | 0.0 |
| Example 1-1 | | | | | | | | | |
| Comparative | ◯ | NMP | 205 | PVDF | 0.25 | Absence | 0 | 1.50 | 0.0 |
| Example 1-2 | | | | | | | | | |
| Comparative | X | H₂O | 170 | PTFE | 0.20 | Absence | 1 | 1.80 | 0.0 |
| Example 1-3 | | | | | | | | | |
| Comparative | X | H₂O | 170 | PTFE | 0.25 | Absence | 3 | 1.23 | 0.0 |
| Example 1-4 | | | | | | | | | |
| Comparative | ◯ | H₂O | 170 | PTFE | 0.24 | Absence | 3 | 1.25 | 0.0 |
| Example 1-5 | | | | | | | | | |
| Comparative | X | H₂O | 170 | PVDF | 0.26 | Absence | 3 | 1.24 | 0.0 |
| Example 1-6 | | | | | | | | | |
| Comparative | ◯ | H₂O | 170 | PVDF | 0.25 | Absence | 3 | 1.27 | 0.0 |
| Example 1-7 | | | | | | | | | |
| Comparative | ◯ | NMP | 220 | PVDF | 0.60 | ◯ | 5 | 0.03 | 63.1 |
| Example 1-8 | | | | | | | | | |
| Example 1-1 | X | H₂O | 170 | PTFE | 0.34 | Absence | 5 | 0.70 | 0.0 |
| Example 1-2 | X | NMP | 205 | PTFE | 0.31 | ◯ | 3 | 0.58 | 0.0 |
| Example 1-3 | X | NMP | 205 | PVDF | 0.36 | ◯ | 3 | 0.41 | 0.9 |
| Example 1-4 | ◯ | NMP | 205 | PVDF | 0.30 | ◯ | 1 | 0.60 | 0.0 |
| Example 1-5 | ◯ | NMP | 205 | PVDF | 0.40 | ◯ | 3 | 0.20 | 2.3 |
| Example 1-6 | ◯ | NMP | 205 | PVDF | 0.55 | ◯ | 5 | 0.05 | 9.5 |

### Results of Examples 1-1 to 1-6 and Comparative Examples 1-1 to 1-8

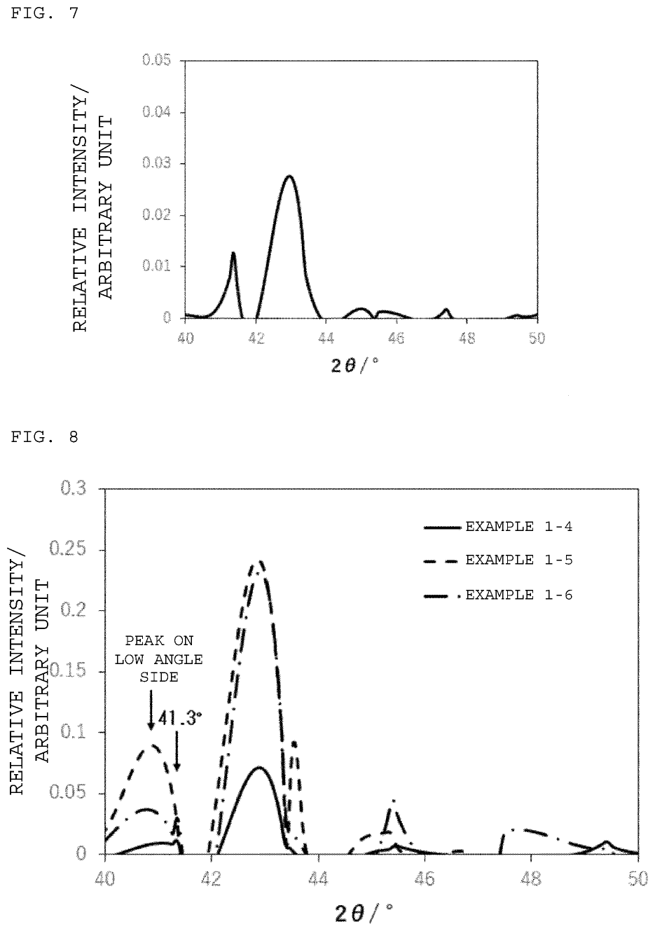

The shift of the X-ray diffraction spectrum of Examples 1-1 and 1-4 to 1-6 to the low angle side will be described with reference to FIGS. 6 to 8. FIG. 6 is a graph showing the X-ray diffraction spectrum of the positive electrode mixture of Example 1-1. FIG. 7 is an enlarged view of a portion A in the vicinity of 41.3° in FIG. 6. FIG. 8 is a graph showing the X-ray diffraction spectrum of the positive electrode mixture of Examples 1-4 to 1-6.

As shown in FIGS. 6 to 7, in the X-ray diffraction spectrum of Example 1-1, a peak at a diffraction angle 2θ=41.3° attributed to Mn⁴⁺ (MnO₂) was observed, and a peak (that is, the shift to the low angle side) located on the low angle side at a diffraction angle 2θ=41.3° attributed to Mn²⁺ (MnO) was not observed.

As shown in FIG. 8, in Example 1-4 (in FIG. 8, indicated by the solid line) and Example 1-6 (in FIG. 8, indicated by the one-dot chain line), the peak at a diffraction angle 2θ=41.3° and the peak located on the low angle side were observed. In Example 1-5 (in FIG. 8, indicated by the broken line), the peak located on the low angle side at a diffraction angle 2θ=41.3° was observed.

As shown in Table 1, the batteries 1 of Examples 1-1 to 1-6 included a positive electrode containing a positive electrode mixture containing manganese dioxide, a negative electrode containing a lithium element, and a non-aqueous electrolytic solution. In the XPS spectrum of the positive electrode mixture, the peak intensity ratio I₂/I₁ at Mn2p_{3/2} was 0.31 to 0.55. As shown in Table 1, the batteries 1 of Examples 1-1 to 1-6 had a swelling amount of 0.05 to 0.70 mm and an OCV failure rate of 0.0 to 9.5%.

On the other hand, in the batteries of Comparative Examples 1-1 to 1-8, the peak intensity ratio I₂/I₁ of Mn2p_{3/2} in the XPS spectrum of the positive electrode mixture was 0.20 to 0.26 or 0.60.

As shown in Table 1, in the batteries of Comparative Examples 1-1 to 1-7, the swelling amount was 1.23 to 1.80 mm. In the battery of Comparative Example 1-8, the OCV failure rate was 63.1%.

Thus, in the batteries 1 of Examples 1-1 to 1-6, as compared with the batteries of Comparative Examples 1-1 to 1-8, the swelling amount is small, the OCV failure rate is reduced, and the heat resistance under a high temperature environment is excellent.

### Examples 2-1 to 2-2 and Examples 3-1 to 3-4: Solvent of Non-Aqueous Electrolytic Solution

The batteries 1 of Examples 2-1 to 2-2 and Examples 3-1 to 3-4 were produced similarly to Example 1-5 except that the type of the solvent in the positive electrode mixture dispersion liquid was changed as shown in Table 2. For the batteries 1 of Examples 2-1 to 2-2 and Examples 3-1 to 3-4, the intensity ratio I₂/I₁ of the positive electrode mixture 31 was determined similarly to Example 1-1. In addition, evaluation (measurement of the swelling amount after heat treatment (260° C., 5 minutes)) was performed similarly to Example 1-5. In addition, as another evaluation, measurement of the swelling amount after the heat treatment (260° C., 5 minutes) and measurement of the open circuit voltage (OCV) were performed. The measurement results and the evaluation results are summarized in Table 2.

TABLE 2

| | | | | | | | | | Evaluation | | |
|---|---|---|---|---|---|---|---|---|---|---|---|
| | | | | | | Electrolytic solution | | | | | OCV |
| | Positive electrode mixture | | | | | | Solvent | | Swelling amount | | (V) |
| | | | Drying | Positive | | Dicarboxylic | | Mixing | [260° C., | [150° C., | [150° C., |
| | Spray | Treatment | temperature | electrode | | anhydride | | ratio | 5 | 100 | 100 |
| | dry | solvent | (° C.) | binder | I₂/I₁ | (wt %) | Type | (w/w) | minutes] | hours] | hours] |
| Example | ◯ | NMP | 205 | PVDF | 0.40 | 3 | PC | — | 0.20 | 0.29 | 0.93 |
| 1-5 | | | | | | | | | | | |
| Example | ◯ | NMP | 205 | PVDF | 0.42 | 3 | BC | — | 0.38 | 0.26 | 1.01 |
| 2-1 | | | | | | | | | | | |
| Example | ◯ | NMP | 205 | PVDF | 0.38 | 3 | EC, | EC/TG = 1/1 | 0.63 | — | — |
| 2-2 | | | | | | | TG | | | | |
| Example | ◯ | NMP | 205 | PVDF | 0.41 | 3 | PC, | PC/TG = 1/1 | 0.42 | 0.12 | 2.01 |
| 3-1 | | | | | | | TG | | | | |
| Example | ◯ | NMP | 205 | PVDF | 0.43 | 3 | PC, | PC/TEG = 1/1 | 0.39 | 0.13 | 1.91 |
| 3-2 | | | | | | | TEG | | | | |
| Example | ◯ | NMP | 205 | PVDF | 0.41 | 3 | PC, | PC/DG = 1/1 | 0.53 | 0.13 | 1.87 |
| 3-3 | | | | | | | DG | | | | |
| Example | ◯ | NMP | 205 | PVDF | 0.41 | 3 | PC, | PC/DME = 1/1 | 0.61 | — | — |
| 3-4 | | | | | | | DME | | | | |

EC: ethylene carbonate,
PC: propylene carbonate,
BC: butylene carbonate,
DME: 1,2-dimethoxyethane (monoglyme),
DG: diglyme,
TG: triglyme,
TEG: tetraglyme

As shown in Table 2, the batteries 1 of Examples 2-1 to 2-2 and 3-1 to 3-4 included a positive electrode containing a positive electrode mixture containing manganese dioxide, a negative electrode containing a lithium element, and a non-aqueous electrolytic solution. In the XPS spectrum of the positive electrode mixture, the peak intensity ratio I₂/I₁ at Mn2p_{3/2} was 0.38 to 0.43. Among them, in the batteries 1 of Examples 1-5, 2-1, and 3-1 to 3-4, the non-aqueous electrolytic solution contained a solvent of at least one of propylene carbonate and butylene carbonate. As shown in Table 2, the batteries 1 of Examples 1-5, 2-1, and 3-1 to 3-4 had a swelling amount (swelling amount at 260° C. for 5 minutes) of 0.20 to 0.61 mm.

On the other hand, in the battery 1 of Example 2-2, the non-aqueous electrolytic solution contained ethylene carbonate and did not contain a solvent of at least one of propylene carbonate and butylene carbonate. As shown in Table 2, the battery 1 of Example 2-2 had a swelling amount (swelling amount at 150° C. for 100 hours) of 0.63 mm.

Thus, the batteries 1 of Examples 1-5, 2-1, and 3-1 to 3-4 had a small swelling amount and exhibited excellent heat resistance under a high temperature environment (260° C., 5 minutes) as compared with the battery of Example 2-2.

As shown in Table 2, in the batteries 1 of Examples 3-1 to 3-3, the non-aqueous electrolytic solution contained at least one solvent of propylene carbonate and butylene carbonate, and further contained at least one selected from the group consisting of diglyme, triglyme, and tetraglyme. As shown in Table 3, the batteries 1 of Examples 3-1 to 3-3 had a swelling amount of 0.12 to 0.13 mm.

On the other hand, as shown in Table 2, in the batteries 1 of Examples 1-5 and 2-2, the non-aqueous electrolytic solution contained only a solvent of at least one of propylene carbonate and butylene carbonate.

As shown in Table 3, the batteries 1 of Examples 1-5 and 2-2 had a swelling amount of 0.26 to 0.29 mm.

Thus, the batteries 1 of Examples 3-1 to 3-3 had a small swelling amount and exhibited excellent heat resistance under a high temperature environment (150° C., 100 hours) as compared with the batteries of Examples 1-5 and 2-2.

### Examples 4-1 to 4-4: Positive Electrode Ring

Batteries of Examples 4-1 to 4-4 were produced similarly to Example 1-5 except that the positive electrode ring was provided. The arrangement of the positive electrode ring and the presence or absence of fixing of the positive electrode ring to the positive electrode container by welding are summarized in Table 3. The swelling amount was measured similarly to Example 1-5. In addition, after storage at 260° C. for 5 minutes, 168 mAh discharge was performed at 23° C. and 15 kΩ, that is, the electrical resistance in a state of DOD of 80% was measured. The results are summarized in Table 3.

[Table 3]

As shown in Table 3, the batteries 1 of Examples 4-1 to 4-4 further included the positive electrode ring, and among these, in Examples 4-1 to 4-2, the positive electrode ring was fixed to the positive electrode container by welding. Among Examples 4-1 to 4-4, in Examples 4-1 to 4-2 in which the positive electrode ring was fixed to the positive electrode container by welding, the electrical resistance after DOD of 80% was reduced as compared with Examples 4-3 to 4-4 in which the positive electrode ring was not fixed to the positive electrode container by welding.

### Examples 5-1 to 5-2 Content of Positive Electrode Conductive Agent

Batteries of Examples 5-1 to 5-2 were produced similarly to 1-5 except that the contents of carbon black (CB) and graphite as the positive electrode conductive agent were changed. The swelling amount was measured similarly to Example 1-5. In addition, the discharge capacity and the pellet liquid absorption amount were measured. The measurement results are summarized in Table 4.

TABLE 4

| | Positive electrode mixture | | | | | | | | | | | |
|---|---|---|---|---|---|---|---|---|---|---|---|---|
| | | | | | | | | | Positive | Evaluation | | |
| | Reduction treatment of | | | | | | Content of | | electrode | 260° C., | | |
| | positive electrode active | | | Positive | | | positive | | active | 5 | | Pellet |
| | material | | | electrode | | | electrode | | material | minutes | | liquid |
| | | | Treatment | binder | | | conductive | | MnO₂ | Swelling | Discharge | absorption |
| | Spray | Treatment | temperature | | Content | I₂/ | agent | | Content | amount | capacity | amount |
| | drying | solvent | (° C.) | Type | (%) | I₁ | CB | Graphite | (%) | (mm) | (mAh) | (mg) |
| Example | ◯ | NMP | 205 | PVDF | 1.00 | 0.40 | 0.50 | 6.50 | 92.00 | 0.20 | 210 | 80 |
| 1-5 | | | | | | | | | | | | |
| Example | ◯ | NMP | 205 | PVDF | 1.00 | 0.41 | 4.00 | 3.00 | 92.00 | 0.21 | 200 | 122 |
| 5-1 | | | | | | | | | | | | |
| Example | ◯ | NMP | 205 | PVDF | 1.00 | 0.39 | 4.20 | 3.00 | 92.00 | 0.20 | 160 | 122 |
| 5-2 | | | | | | | | | | | | |

As shown in Table 4, in Examples 1-5 and 5-1 in which the content of carbon black (CB) as the positive electrode conductive agent is 4.0% or less, the discharge capacity can be increased while the swelling amount is maintained, as compared with Example 5-2 in which the content of CB exceeds 4.0%. In Examples 5-1 to 5-2 in which the content of carbon black (CB) as the positive electrode conductive agent is 4.0% or more, the pellet liquid absorption amount can be increased while maintaining the swelling amount, as compared with Example 1-5 in which the content of CB is less than 4.0%.

### Examples 6-1 to 6-2: Constituent Material of Negative Electrode

In Examples 6-1 to 6-2, batteries were prepared similarly to Example 1-5 except that the constituent material of the negative electrode was changed. The measurement results are summarized in Table 5. In Table 5, “Li+Al” in the “negative electrode” column represents a lithium aluminum alloy, and “Li+carbon” represents a reaction product of carbon black and lithium. The swelling amount was measured similarly to Example 1-5.

TABLE 5

| | Positive electrode mixture | | | | | | | Evaluation |
|---|---|---|---|---|---|---|---|---|
| | Reduction treatment of positive | | | | | | | 260° C., 5 |
| | electrode active material | | | Positive electrode | | | | minutes |
| | | | Treatment | binder | | | Negative | Swelling |
| | Spray | Treatment | temperature | | Content | I₂/ | electrode | amount |
| | drying | solvent | (° C.) | Type | (%) | I₁ | Type | (mm) |
| Example 1-5 | ◯ | NMP | 205 | PVDF | 3.00 | 0.40 | Li | 0.20 |
| Example 6-1 | ◯ | NMP | 205 | PVDF | 3.00 | 0.44 | Li + AI | 0.13 |
| Example 6-2 | ◯ | NMP | 205 | PVDF | 3.00 | 0.42 | Li + carbon | 0.12 |

As shown in Table 5, in Examples 1-5 and 6-1 to 6-2, Examples 6-1 to 6-2 including the negative electrode containing a lithium alloy had a reduced swelling amount and improved heat resistance as compared with Example 1-5 including the negative electrode containing metal lithium.

### Examples 7-1 to 7-2: Mass Ratio W₂/W₁

In Examples 7-1 to 7-2, batteries were produced similarly to Example 1-5 except that the ratio (W₂/W₁) of the mass W₁ of the electrolytic solution to the mass W₂ of the positive electrode mixture was changed. The discharge capacity after the heat treatment (260° C., 5 minutes), the discharge evaluation according to the IEC standard, and the leakage evaluation were performed. The measurement results and the evaluation results are summarized in Table 6.

TABLE 6

| | | | | | | | | | | Evaluation | | |
|---|---|---|---|---|---|---|---|---|---|---|---|---|
| | | | | | | | | | | Discharge | | |
| | | | | | | | | | | capacity | Acceptance | |
| | | | | | | | | | | at | of | |
| | | | | | | | | | | 260° C. | discharge | |
| | Positive electrode mixture | | | | | | Electrolytic | Mass | | after | according | Liquid |
| | | | Treatment | Positive | Mass | | solution | ratio | | 5 | to | leakage |
| | Spray | Treatment | temperature | electrode | W₂ | I₂/ | Mass | W₁/ | Gasket | minutes | IEC | after |
| | dry | solvent | (° C.) | binder | (g) | I₁ | W₁ (g) | W₂ | Type | (mAh) | standard | storage |
| Example | ◯ | NMP | 205 | PVDF | 0.86 | 0.40 | 0.20 | 0.23 | PPS | 210 | ◯ | Absence |
| 1-5 | | | | | | | | | | | | |
| Example | ◯ | NMP | 205 | PVDF | 0.86 | 0.41 | 0.18 | 0.21 | PPS | 189 | ◯ | Absence |
| 7-1 | | | | | | | | | | | | |
| Example | ◯ | NMP | 205 | PVDF | 0.86 | 0.38 | 0.17 | 0.20 | PPS | 181 | ◯ | Absence |
| 7-2 | | | | | | | | | | | | |

In Example 1-5 and Examples 7-1 to 7-2 in which 0.20 W₂/W₁ 0.23, discharge according to the IEC standard was satisfied, discharge under a high temperature environment was also good, and leakage after storage did not occur.

### Examples 8-1 to 8-4

In Examples 8-1 to 8-4, batteries were produced similarly to Example 1-5 except that the specific surface area of the positive electrode mixture was changed (Table 7).

TABLE 7

| | | | | | | Evaluation | |
|---|---|---|---|---|---|---|---|
| | Positive electrode mixture | | | | Dicarboxylic | 260° C., 5 | |
| | Reduction treatment | | | Specific | anhydride | minutes | |
| | | | Positive | surface | PMDA | Swelling | |
| | | Treatment | electrode | area | Content | amount | OCV |
| | Spray dry | solvent | binder | (m²/g) | (%) | (mm) | (V) |
| Example 1-5 | ◯ | NMP | PVDF | 15.0 | 3.00 | 0.20 | 3.21 |
| Example 8-1 | ◯ | NMP | PVDF | 10.3 | 3.00 | 0.14 | 3.13 |
| Example 8-2 | ◯ | NMP | PVDF | 28.0 | 3.00 | 0.70 | 3.29 |
| Comparative | ◯ | NMP | PVDF | 30.1 | 3.00 | 0.75 | 3.31 |
| Example 8-3 | | | | | | | |
| Comparative | ◯ | NMP | PVDF | 9.2 | 3.00 | 0.12 | 3.05 |
| Example 8-4 | | | | | | | |

Among Examples 1-5 and 8-1 to 8-4, in Examples 1-5 and 8-1 to 8-2 in which the specific surface area of the positive electrode mixture was 10 m²/g or more and 30 m²/g or less, the swelling amount was 0.70 mm or less and the OCV was 3.13 V or more as compared with Examples 8-3 to 8-4 in which the specific surface area of the positive electrode mixture was less than 10 m²/g or more than 30 m²/g.

### Examples 9-1 to 9-4

In Examples 9-1 to 9-4, batteries were produced similarly to Example 1-5 except that the content of the positive electrode active material and the content of the positive electrode conductive agent in the positive electrode mixture were changed. In addition, the discharge capacity and the pellet crack occurrence rate were measured. The measurement results are summarized in Table 8.

TABLE 8

| | Positive electrode mixture | | | | | | | | | |
|---|---|---|---|---|---|---|---|---|---|---|
| | | | | | | Positive | | | | |
| | | | | Positive | Positive | electrode | | | | |
| | | | Positive | electrode | electrode | conductive | | | Evaluation | |
| | | | electrode | active | conductive | agent | | Dicarboxylic | | Pellet |
| | Reduction | | binder | material | agent | Content | | anhydride | | crack |
| | treatment | | Content | Content | Content | of | | PMDA | Discharge | occurrence |
| | Spray | Treatment | of PVDF | of MnO₂ | of CB | graphite | I₂/ | Content | capacity | rate |
| | dry | solvent | (%) | (%) | (%) | (%) | I₁ | (%) | (unit) | (% ) |
| Example | ◯ | NMP | 1.0 | 92 | 0.5 | 6.5 | 0.40 | 3.00 | 210 | 0 |
| 1-5 | | | | | | | | | | |
| Example | ◯ | NMP | 1.0 | 80 | 0.5 | 18.5 | 0.45 | 3.00 | 180 | 0 |
| 9-1 | | | | | | | | | | |
| Example | ◯ | NMP | 1.0 | 94 | 0.5 | 4.5 | 0.38 | 3.00 | 214 | 9 |
| 9-2 | | | | | | | | | | |
| Example | ◯ | NMP | 1.0 | 95 | 0.5 | 3.5 | 0.36 | 3.00 | 216 | 31 |
| 9-3 | | | | | | | | | | |
| Example | ◯ | NMP | 1.0 | 78 | 0.5 | 20.5 | 0.47 | 3.00 | 178 | 0 |
| 9-4 | | | | | | | | | | |

As shown in Table 8, among Examples 1-5 and 9-1 to 9-4, in Examples 1-5, 9-1, and 9-4 in which the content of graphite as the positive electrode conductive agent was 6.5% by weight to 20.5% by weight with respect to 100% by mass of the positive electrode 30, the pellet crack occurrence rate was lower than that in Examples 9-2 to 9-3 in which the content was 3.5% by weight to 4.5% by weight. Among Examples 1-5 and 9-1 to 9-4, in Examples 1-5 and 9-2 to 9-3 in which the content of graphite as the positive electrode conductive agent was 3.5% by weight to 6.5% by weight with respect to 100% by mass of the positive electrode 30, the discharge capacity was higher than that in Examples 9-1 and 9-4 in which the content was 18.5% by weight to 20.5% by weight.

The non-aqueous electrolytic solution battery according to an embodiment of the present disclosure is further described as follows.

<1>

A flat-type non-aqueous electrolytic solution battery including a positive electrode containing a positive electrode mixture containing manganese dioxide, a negative electrode containing a lithium element, and a non-aqueous electrolytic solution,
wherein in an X-ray photoelectron spectroscopy (XPS) spectrum of the positive electrode mixture, a peak intensity ratio I₂/I₁ of Mn2p_{3/2} satisfies the following formula (1):

$$\begin{matrix}[ Math . 5 ] & \\ 0.3 ≦ \frac{{I}_{2}}{{I}_{1}} ≦ 0.55 & ( 1 )\end{matrix}$$

[in the formula (1), I₁ represents a peak intensity at a binding energy of 642 eV, and I₂ represents a peak intensity at a binding energy of 640 eV].
<2>

The non-aqueous electrolytic solution battery according to <1>, wherein the positive electrode mixture has a diffraction peak of a (200) plane shifted to a low angle side of a diffraction angle 2θ=41.3°+0.1° in an X-ray diffraction spectrum obtained by X-ray diffraction measurement using a CuKα ray as an X-ray source.

<3>

The non-aqueous electrolytic solution battery according to <1> or <2>, wherein the non-aqueous electrolytic solution contains dicarboxylic anhydride represented by the general formula (1):

[Chem. 3]

W(—C(═0)—0—C(═0)—)z . . . (1)

[in the general formula (1), W represents a benzene-based aromatic ring from which 2z hydrogens have been eliminated, and z represents an integer of 2 or more].
<4>

The non-aqueous electrolytic solution battery according to any one of <1> to <3>, wherein the positive electrode mixture contains a positive electrode binder, and the positive electrode binder is polyvinylidene fluoride.

<5>

The non-aqueous electrolytic solution battery according to any one of <1> to <4>, wherein the non-aqueous electrolytic solution contains a solvent of at least one of propylene carbonate and butylene carbonate.

<6>

The non-aqueous electrolytic solution battery according to any one of <1> to <5>, wherein the non-aqueous electrolytic solution further contains at least one solvent selected from the group consisting of diglyme, triglyme, and tetraglyme.

<7>

The non-aqueous electrolytic solution battery according to <1> or <2>, wherein the non-aqueous electrolytic solution contains lithium perchlorate, and a content of the lithium perchlorate is 0.5% by mass or more and 12% by mass or less with respect to 100% by mass of the non-aqueous electrolytic solution.

<8>

The non-aqueous electrolytic solution battery according to any one of <1> to <7>, further including:
a positive electrode ring; and
a positive electrode container that houses the positive electrode mixture,
wherein
the positive electrode ring has an L shape in a sectional view,
the positive electrode ring covers a part of a side surface and a part of a bottom surface of the positive electrode mixture, and
a part of the positive electrode ring is joined to an inner bottom surface of the positive electrode container.
   <9>

The non-aqueous electrolytic solution battery according to any one of <1> to <8>, wherein the positive electrode mixture further contains carbon black, and a content of the carbon black is 0.5% by mass or more and 4% by mass or less with respect to 100% by mass of the positive electrode mixture. <10>

The non-aqueous electrolytic solution battery according to any one of <1> to <9>, further including:
a separator between the positive electrode mixture and the negative electrode; and
a negative electrode conductive layer between the negative electrode and the separator,
wherein the negative electrode conductive layer contains at least one of silver, a lithium aluminum alloy, and a carbon material.
   <11>

The non-aqueous electrolytic solution battery according to any one of <1> to <10>, further including a gasket,
wherein
the gasket contains polyphenylene sulfide, and
a mass ratio of the non-aqueous electrolytic solution to the positive electrode mixture satisfies the following formula (2):

$$\begin{matrix}[ Math . 6 ] & \\ 0.2 ≦ \frac{{W}_{2}}{{W}_{1}} ≦ 0.23 & ( 2 )\end{matrix}$$

[in the formula (2), W₂ (g) represents the mass of the positive electrode mixture, and W₁ (g) represents the mass of the non-aqueous electrolytic solution].
<12>

The non-aqueous electrolytic solution battery according to any one of <1> to <11>, wherein the positive electrode mixture has a specific surface area of 10.3 m²/g or more and 28.0 m²/g or less.

<13>

The non-aqueous electrolytic solution battery according to any one of <1> to <12>, wherein a content of the manganese dioxide is 80% by mass or more and 94% by mass or less with respect to 100% by mass of the positive electrode mixture.

<14>

The non-aqueous electrolytic solution battery according to any one of <1> to <13>, further including a battery can in which the positive electrode, the negative electrode, and the non-aqueous electrolytic solution are housed, wherein the battery can includes a metallic positive electrode container and a metallic negative electrode container.

<15>

The non-aqueous electrolytic solution battery according to any one of <1> to <14>, wherein the positive electrode mixture further contains carbon black, and the content of the carbon black is 4% by mass or more with respect to 100% by mass of the positive electrode mixture.

The non-aqueous electrolytic solution battery according to the present disclosure is used for small electronic devices, and for example, can be used for general electronic devices (more specifically, a watch, a camera, a calculator, an electronic notebook, and a portable game machine, and the like), accessory devices (more specifically, a remote controller, a smart key, and the like), small industrial devices (more specifically, a tag and the like), small medical devices (more specifically, an electronic thermometer and the like), and other devices (more specifically, memory backup and the like).

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A flat-type non-aqueous electrolytic solution battery comprising:
a positive electrode including a positive electrode mixture including manganese dioxide;
a negative electrode including a lithium element; and
a non-aqueous electrolytic solution,
wherein in an X-ray photoelectron spectroscopy (XPS) spectrum of the positive electrode mixture, a peak intensity ratio I₂/I₁ of Mn2p_{3/2} satisfies a formula (1) as follows:
$$0.3 ≦ \frac{{I}_{2}}{{I}_{1}} ≦ 0.55 \qquad ( 1 )$$
in the formula (1), I₁ represents a peak intensity at a binding energy of 642 eV, and I₂ represents a peak intensity at a binding energy of 640 eV.

2. The non-aqueous electrolytic solution battery according to claim 1, wherein the positive electrode mixture has a diffraction peak of a (200) plane shifted to a low angle side of a diffraction angle 2θ=41.3°±0.1° in an X-ray diffraction spectrum obtained by X-ray diffraction measurement using a CuKα ray as an X-ray source.

3. The non-aqueous electrolytic solution battery according to claim 1, wherein the non-aqueous electrolytic solution contains dicarboxylic anhydride represented by a general formula (1):
W(—C(═0)—0—C(═0)—)z . . . (1)
in the general formula (1), W represents a benzene-based aromatic ring from which 2z hydrogens have been eliminated, and z represents an integer of 2 or more.

4. The non-aqueous electrolytic solution battery according to claim 1, wherein the positive electrode mixture includes a positive electrode binder, and the positive electrode binder is polyvinylidene fluoride.

5. The non-aqueous electrolytic solution battery according to claim 1, wherein the non-aqueous electrolytic solution includes a solvent of at least one of propylene carbonate and butylene carbonate.

6. The non-aqueous electrolytic solution battery according to claim 5, wherein the non-aqueous electrolytic solution further includes at least one solvent selected from the group consisting of diglyme, triglyme, and tetraglyme.

7. The non-aqueous electrolytic solution battery according to claim 1, wherein the non-aqueous electrolytic solution contains lithium perchlorate, and a content of the lithium perchlorate is 0.5% by mass or more and 12% by mass or less with respect to 100% by mass of the non-aqueous electrolytic solution.

8. The non-aqueous electrolytic solution battery according to claim 1, further comprising:
a positive electrode ring; and
a positive electrode container that houses the positive electrode mixture,
wherein
the positive electrode ring has an L shape in a sectional view,
the positive electrode ring covers a part of a side surface and a part of a bottom surface of the positive electrode mixture, and
a part of the positive electrode ring is joined to an inner bottom surface of the positive electrode container.

9. The non-aqueous electrolytic solution battery according to claim 1, wherein the positive electrode mixture further includes carbon black, and a content of the carbon black is 0.5% by mass or more and 4% by mass or less with respect to 100% by mass of the positive electrode mixture.

10. The non-aqueous electrolytic solution battery according to claim 1, further comprising:
a separator between the positive electrode mixture and the negative electrode; and
a negative electrode conductive layer between the negative electrode and the separator,
wherein the negative electrode conductive layer contains at least one of silver, a lithium aluminum alloy, and a carbon material.

11. The non-aqueous electrolytic solution battery according to claim 1, further comprising a gasket,
wherein the gasket contains polyphenylene sulfide, and
a mass ratio of the non-aqueous electrolytic solution to the positive electrode mixture satisfies a following formula (2):
$$0.2 ≦ \frac{{W}_{2}}{{W}_{1}} ≦ 0.23 \qquad ( 2 )$$
in the formula (2), W₂ (g) represents the mass of the positive electrode mixture, and W₁ (g) represents the mass of the non-aqueous electrolytic solution.

12. The non-aqueous electrolytic solution battery according to claim 1, wherein the positive electrode mixture has a specific surface area of 10.3 m²/g or more and 28.0 m²/g or less.

13. The non-aqueous electrolytic solution battery according to claim 1, wherein a content of the manganese dioxide is 80% by mass or more and 94% by mass or less with respect to 100% by mass of the positive electrode mixture.

14. The non-aqueous electrolytic solution battery according to claim 1, further comprising a battery can in which the positive electrode, the negative electrode, and the non-aqueous electrolytic solution are housed,
wherein the battery can includes a metallic positive electrode container and a metallic negative electrode container.

15. The non-aqueous electrolytic solution battery according to claim 1, wherein the positive electrode mixture further contains carbon black, and the content of the carbon black is 4% by mass or more with respect to 100% by mass of the positive electrode mixture.
